(19) United States
(12) Patent Application Publication
(10) Pub. No.: US 2014/0016428 A1
(43) Pub. Date: Jan. 16, 2014

(54) KNEADING APPARATUS

(71) Applicants: Yasuaki Akai, Tokyo (JP); Tomohiro Wada, Tokyo (JP); Tomoyuki Haneji, Tokyo (JP)

(72) Inventors: Yasuaki Akai, Tokyo (JP); Tomohiro Wada, Tokyo (JP); Tomoyuki Haneji, Tokyo (JP)

(73) Assignee: TAIYO NIPPON SANSO CORPORATION, Tokyo (JP)

(21) Appl. No.: 14/003,875

(22) PCT Filed: Mar. 9, 2012
(86) PCT No.: PCT/JP2012/056180

§ 371 Date: Oct. 1, 2013

(30) Foreign Application Priority Data
Mar. 10, 2011 (JP) 2011-052887
Mar. 10, 2011 (JP) 2011052888

(51) Int. Cl. B29B 7/28

(52) U.S. Cl. CPC B29B 7/28
USPC 366/76.2

(57) ABSTRACT

The present invention includes a kneading chamber (2) which kneads a material to be kneaded (G), a gas introduction part (3) which introduces an inert gas in the chamber (2), a concentration measurement part (4) which measures the oxygen concentration in the chamber (2); an arithmetic operation section (30) which performs operation to make the inside of the chamber (2) achieve the target oxygen concentration; and a control section (31) which controls the part (3) according to the result obtained by the section (30); wherein the section (30) performs operation to set the inside of the chamber (2) to the target oxygen concentration while comparing the oxygen concentration measured during kneading by the part (4) and target oxygen concentration set in advance; and the section (31) controls a purge flow rate and purge time of an inert gas introduced in the kneading chamber (2) from the part (3) based on the operation result, in kneading performed after the operation.

### TECHNICAL FIELD

The present invention relates to a kneading apparatus which is used for, for example, kneading materials such as rubber, sulfur and the like, which are raw materials of tires and the like.

Priority is claimed on Japanese Patent Application No. 2011-052887 and Japanese Patent Application No. 2011-052888, which were filed on Mar. 10, 2011, and the contents thereof are incorporated herein by reference.

### BACKGROUND ART

For example, when a rubber product such as tires is manufactured, additives and compounding agents, such as sulfur, carbon black, oil, an antioxidant and a vulcanization accelerator are added to rubber, which is a raw material of the rubber product, and the mixture is kneaded in a heated state and/or a pressurized state. Furthermore, a kneader (kneading apparatus) such as a Banbury mixer is widely used for such kneading.

The Banbury mixer is a closed type mixer, wherein a material to be kneaded is fed in a kneading chamber having a sealing structure and then plasticized while being heated and/or pressurized, and the material is kneaded by adding a large shearing force by a pair of rotors, which rotate in the opposite directions to each other, while the plasticized state of the material is maintained. Furthermore, when the kneading operation is performed by the Banbury mixer, the state of the material to be kneaded in the kneading chamber is checked and operation management thereof is performed, while a temperature in a kneading chamber, a current value and the like of a motor which drives the rotors are measured.

By the way, in such a closed type kneader, the oxygen concentration of the inside of the aforementioned kneading chamber is set to not more than the ignition limit by, for example, introducing an inert gas such as nitrogen and carbon dioxide in the kneading chamber, so that dust such as sulfur, which scatters in the kneading chamber at the time of kneading, does not react with oxygen in the kneading chamber and therefore ignition is prevented. (For example, Patent Documents 1 and 2)

Furthermore, in a conventional closed type kneader, the measurement of the oxygen concentration is continuously performed. Concretely, an atmospheric gas in the kneading chamber is continuously introduced to an oxygen analyser via piping which is connected to the kneading chamber. Furthermore, in order to protect an oxygen analyser from negative influence caused by dust and the like which are included in an atmospheric gas in the kneading chamber, a filter is generally attached to the middle of piping which is connected with the oxygen analyser, so that the filter collects dust and the like included in an atmospheric gas which flows in the piping.

However, dust and the like which are collected by the filter have high viscosity, and the diameter of the piping is small (about φ6 mm). Accordingly, clogging of the piping and the filter tends to be caused. Therefore, if measurement of the oxygen concentration is continuously performed during the kneading operation similar to that in a conventional kneader, it is necessary to perform troublesome operations such as cleaning of piping, exchange of the filter and the like.

In particular, when a batch type kneader is used wherein a kneading step, that is, the combination of feeding, kneading and discharging, which is performed to treat a batch of materials to be kneaded, is repeated multiple times to treat batches, there are cases in which the kneading step is repeated to treat, for example, about 200 batches for one production cycle. Therefore, there was a need for operations such as piping cleaning, exchange of a filter and the like described above, which were at least performed once a day.

Accordingly, it is desired that the oxygen concentration in a kneading chamber be stably measured without performing operations such as piping cleaning and exchange of a filter, while suppressing such clogging of piping and a filter.

Prior art documents
Patent documents

Japanese Unexamined Patent Application, First Publication No. 2006-327052

Japanese Unexamined Patent Application, First Publication No. 2009-90252

### DISCLOSURE OF INVENTION

Problems to be solved by the Invention

The present invention is proposed in view of the aforementioned conventional circumstances. The purpose of the invention is to provide a kneading apparatus which can suppress clogging of piping and a filter, and can make it possible to maintain the oxygen concentration in a kneading chamber to the target value, even if the frequency of cleaning of piping and exchange of a filter is reduced, that is, operations such as cleaning of piping and exchange of a filter are not frequently performed.

The inventors of the present invention studied whether clogging of piping and a filter can be suppressed, even when continuous measurement of the oxygen concentration in a kneading chamber is not required, that is, even when the number of times of cleaning of piping and exchange of a filter is reduced or such operations are not performed. Thus, they found that such suppression becomes possible by performing special procedures for piping and a filter.

Furthermore, they found that, in order to eliminate the requirement for continuous measurement of the oxygen concentration, it is necessary to stably maintain the oxygen concentration of the inside of a kneading chamber at the target value (for example, not more than the ignition limit) for every batch, and it is necessary to make an accurate prediction of a flow rate of an inert gas in advance before the batch treatment is started, wherein the inert gas is introduced into the kneading chamber and the like and the flow rate is required to stabilize the oxygen concentration in the kneading chamber.

### Means for Solving the Problems

An apparatus of the first aspect of the present invention is an apparatus represented by (1) shown below.

(1) A kneading apparatus comprising:

a kneading chamber which kneads a material to be kneaded; a gas introduction part which introduces an inert gas in the kneading chamber; a concentration measurement part which measures oxygen concentration of the inside of the kneading chamber;

an arithmetic operation section which performs an arithmetic operation to make the inside of the kneading chamber achieve target concentration; and

a control section which controls the gas introduction part based on the arithmetic result obtained by the arithmetic operation section; wherein

the arithmetic operation section performs the arithmetic operation to set the inside of the kneading chamber to the target oxygen concentration while comparing the oxygen concentration which is actually measured during kneading by the concentration measurement part and the target oxygen concentration which is set in advance, and

in a kneading step which is performed after the arithmetic operation, the control section controls a purge flow rate and purge time of an inert gas, which is introduced in the kneading chamber from the gas introduction part, based on the obtained arithmetic result obtained by the arithmetic operation section.

The apparatus of the first aspect of the present invention preferably has the following characteristics shown below.

(2) The apparatus of (1) is a batch type kneading apparatus, wherein feeding, kneading and discharging of a material to be kneaded are performed as a kneading step to treat one batch, and the kneading step is repeated two or more times; the arithmetic operation section repeats arithmetic operation to maintain the target oxygen concentration for each batch; and the control section controls the purge flow rate and purge time of the inert gas, which is introduced in the kneading chamber from the gas introduction part, based on the arithmetic results.

(3) The apparatus of (2) is an apparatus wherein the control section exposes the inside of the kneading chamber to air before each batch starts, seals the kneading chamber after the exposure to air, and starts the introduction of an inert gas into the kneading chamber by the gas introduction part.

(4) The apparatus of (2) or (3) is an apparatus wherein the inside of the kneading chamber is exposed to air before the initial batch starts and then the kneading chamber is sealed after the exposure,

the gas introduction part introduces an inert gas in the kneading chamber until the oxygen concentration in the kneading chamber becomes the target oxygen concentration, while the concentration measurement part measures the oxygen concentration in the sealed kneading chamber,

subsequently, the arithmetic operation section calculates a purge flow rate of an inert gas which offsets an increment of the oxygen concentration increased in a fixed time, while the concentration measurement part measures the oxygen concentration in the kneading chamber for the fixed time, and

the arithmetic operation section uses the obtained purge flow rate as a standard value, which is used to maintain the inside of the kneading chamber at the target oxygen concentration, during kneading of the initial batch.

(5) The apparatus described in (2) to (4) is an apparatus wherein the concentration measurement part actually measures the oxygen concentration of initial and following batches,

the arithmetic operation section compares the oxygen concentration of a batch, wherein the oxygen concentration is actually measured by the concentration measurement part, and the target oxygen concentration which is set in advance, and performs arithmetic operation to obtain a flow rate of an inert gas which offsets the difference of the oxygen concentrations, and

the obtained flow rate is used as a correction value to maintain the inside of the kneading chamber to the target oxygen concentration during kneading of a subsequent batch, which is treated after the aforementioned batch wherein the oxygen concentration thereof is actually measured.

(6) The apparatus described in (5) is an apparatus wherein, when the oxygen concentration of the batch which is actually measured by the concentration measurement part is included in a predetermined allowable range which includes the target oxygen concentration,

arithmetic operation performed by the arithmetic operation section is stopped in subsequent and following batches, and

the control section controls the purge flow rate and purge time of the inert gas, which is introduced in the kneading chamber from the gas introduction part during kneading of the subsequent and following batches, based on the arithmetic results which are included in the allowable range.

(7) The apparatus described in (6) is an apparatus wherein, after the arithmetic operation performed by the arithmetic operation section is stopped,

the concentration measurement part measures the oxygen concentration in the kneading chamber on a regular basis,

the arithmetic operation section resumes arithmetic operation when the measured oxygen concentration exceeds the allowable range, and

the control section controls the purge flow rate and purge time of the inert gas, which is introduced in the kneading chamber from the gas introduction part, based on the obtained arithmetic results.

(8) The apparatus described in (7) is an apparatus wherein, when the concentration measurement part measures the oxygen concentration in the kneading chamber on a regular basis and the measured oxygen concentration is lower than the allowable range, the result is notified and the concentration measurement part continues to measure the oxygen concentration in the kneading chamber until the batch is completed.

(9) The apparatus described in (1) to (8) is an apparatus which includes: piping which introduces an atmospheric gas in the kneading chamber to the concentration measurement part;

a filter which collects dust included in the atmospheric gas which flows in the piping; and

a second gas introduction part which introduces a reverse purge gas to the filter from the piping existing at the side of the concentration measurement part.

(10) The apparatus described in (9) is an apparatus which includes a switching part which switches a first flow wherein the atmospheric gas in the kneading chamber flows toward the concentration measurement part in the piping and a second flow wherein the reverse purge gas which is introduced from the second gas introduction part flows toward the filter in the piping;

the switching part releases the first flow and shuts the second flow while the concentration measurement part measures the oxygen concentration in the kneading chamber; and

the switching part shuts the first flow and releases the second flow to introduce a reverse purge gas into the filter from the piping existing at the side of the concentration measurement part, while the concentration measurement part interrupts measurement of the oxygen concentration in the kneading chamber.

(11) The apparatus described in (10) is an apparatus which includes a third gas introduction part which introduces zero gas to the concentration measurement part,

the switching part shuts a third flow wherein the zero gas introduced from the third gas introduction part flows toward the concentration measurement part in the piping, while the concentration measurement part measures the oxygen concentration in the kneading chamber, and

the switching part releases the third flow to let the third flow flow toward the concentration measurement part in the piping, while the concentration measurement part interrupts measurement of the oxygen concentration in the kneading chamber.

(13) The apparatus described in (11) to (12) is an apparatus wherein the zero gas is an inert gas.

(14) The second aspect of the present invention is a kneading apparatus as described in (14) below.

(14) A kneading apparatus comprising:

a kneading chamber in which a material to be kneaded is kneaded;

a first gas introduction part which introduces an inert gas into the kneading chamber;

a concentration measurement part which measures oxygen concentration in the kneading chamber;

a piping which introduces an atmospheric gas in the kneading chamber toward the concentration measurement part;

a filter which collects dust included in the atmospheric gas which flows in the piping; and

a second gas introduction part which introduces a reverse purge gas to the filter from the piping existing at the side of the concentration measurement part.

The apparatus of (14) preferably has the following characteristics shown below.

(15) The apparatus described in (14) is an apparatus which includes a switching part, wherein

the switching part switches a first flow wherein an atmospheric gas in the kneading chamber flows toward the concentration measurement part in the piping and a second flow wherein a reverse purge gas which is introduced from the second gas introduction part flows toward the filter in the piping;

the switching part releases the first flow and shuts the second flow, while the concentration measurement part measures the oxygen concentration in the kneading chamber; and

the switching part shuts the first flow and releases the second flow to introduce a reverse purge gas into the filter from the piping existing at the side of the concentration measurement part, while the concentration measurement part interrupts measurement of the oxygen concentration in the kneading chamber.

(16) The apparatus described in (15) is an apparatus which includes a third gas introduction part which introduces zero gas to the concentration measurement part, wherein

the switching part shuts a third flow wherein the zero gas introduced from the third gas introduction part flows toward the concentration measurement part via the piping, while the concentration measurement part measures the oxygen concentration in the kneading chamber, and

the switching part releases the third flow to let the third flow flow toward the concentration measurement part, while the concentration measurement part interrupts measurement of the oxygen concentration in the kneading chamber.

(17) The apparatus described in (14) to (16) is an apparatus which includes:

a dust collector which collects dust included in the kneading chamber,

piping which connects the dust collector and the filter, and

an on-off valve which is configured to open and close the piping, wherein,

when the concentration measurement part stops measurement of the oxygen concentration in the kneading chamber, the piping is opened by the on-off valve to remove dust, which has been collected to the filter, while performing aspiration by the dust collector.

(18) The apparatus described in (14) to (17) is an apparatus wherein the reverse purge gas is an inert gas.

(19) The apparatus described in (16) to (18) is an apparatus wherein the zero gas is an inert gas.

The third aspect of the present invention is a kneading process described below.

(20) A kneading process, wherein the kneading apparatus (1) is used and a material to be kneaded is fed and kneaded in a kneading chamber thereof and discharged therefrom, the method comprising;

a step (a) of performing arithmetic operation by the arithmetic operation section to make the inside of the kneading chamber achieve the target concentration while comparing the oxygen concentration which is actually measured during kneading by the concentration measurement part and the target oxygen concentration which is set in advance; and

a step (b) of controlling the purge flow rate and purge time of the inert gas, which is introduced in the kneading chamber from the gas introduction part, based on the obtained arithmetic result by the control section during kneading which is performed after the arithmetic operation.

The kneading process (20) preferably includes the following characteristics.

(21) The steps (a) and (b) include sub-steps (1) to (5) shown below:

(1) an initial purge step wherein

initial purge time, which is used for making the inside of the kneading chamber, which is sealed after exposure to air, achieve a target oxygen concentration, is obtained based on a value of an initial purge flow rate which is set in advance,

an inert gas is fed in the kneading chamber at the initial purge flow rate and the introduction of the inert gas is stopped when the initial purge time has passed, and variations of the oxygen concentration of the inside of the kneading chamber are measured during a fixed period;

(2) an initial batch step which includes steps (2a) to (2c) in this order:

(2a) a purge before kneading step wherein a material to be kneaded is fed in the kneading chamber and sealed, and an inert gas is introduced in the kneading chamber at a predetermined purge flow rate and purge time;

(2b) a purge during kneading step wherein kneading of the material to be kneaded is started after the purge time has passed, and variations of the oxygen concentration during kneading are measured while an inert gas is introduced in the kneading chamber at the purge flow rate which is obtained based on the variations of the oxygen concentration obtained in in the step (1);

(2c) a discharging step wherein the material to be kneaded is discharged from the kneading chamber after kneading;

(3) a step wherein whether or not the variations of the oxygen concentration which is measured in the steps for a previous batch are in a predetermined allowable range is confirmed, and, when it is confirmed that the variations are not included in the allowable range, a step (4) is performed, and when it is confirmed that the variations are included in the allowable range, a step (5) is performed;

(4) a batch step wherein the step is performed for the second and following batches, and includes the following steps (4a) to (4c) in this order:

(4a) a purge before kneading step wherein a material to be kneaded is fed in the kneading chamber, from which a material to be kneaded of a previous batch has been discharged, and then, the chamber is sealed and an inert gas is introduced in the kneading chamber at the predetermined purge flow rate and purge time;

(4b) a purge during kneading step wherein kneading of the material to be kneaded is started when the purge time has passed, and variations of the oxygen concentration during kneading are measured, while an inert gas is introduced in the kneading chamber at a purge flow rate, which offsets the variations of the oxygen concentration obtained in the purge during kneading step performed for the previous batch;

(4c) a discharging step wherein the material to be kneaded is discharged from the kneading chamber; and (5) a batch step which is performed after arithmetic operation is stopped, and includes the following steps (5a) to (5c) in this order:

(5a) a purge before kneading step wherein a material to be kneaded is fed in the kneading chamber, from which a material to be kneaded of a previous batch has been discharged, and then, the chamber is sealed and an inert gas is introduced in the kneading chamber at the predetermined purge flow rate and purge time;

(5b) a purge during kneading step wherein kneading of the material to be kneaded is started when the purge time has passed, and inert gas is introduced in the kneading chamber at a purge flow rate, which is the same as the flow rate used in the purge during kneading step performed for the previous batch;

(5c) a discharging step wherein the material to be kneaded is discharged from the kneading chamber;

wherein the sub-steps include a step of returning to the step (3) for confirmation, wherein the step is performed

(i) after the step (4) is performed, or

(ii) after the step (5) is repeatedly performed predetermined times and then a batch step is further performed wherein variations of the oxygen concentration during kneading are measured in the purge during kneading step thereof.

Here, the aforementioned “part” may mean a device, a step, means, a method and the like.

Effects of the Invention

In the first aspect of the present invention, the inside of the kneading chamber can be set to the target oxygen concentration stably, since arithmetic operation is performed while comparing the oxygen concentration which is actually measured and the target oxygen concentration which is set in advance in order to set the inside of the kneading chamber to the target oxygen concentration, and a purge flow rate and purge time of an inert gas, which is introduced in the kneading chamber, is controlled based on the results of said arithmetic operation.

Furthermore, in the first aspect of the present invention, it is not necessary to always perform measurement of the oxygen concentration in the kneading chamber. That is, it is possible to reduce the number of times of cleaning of piping and exchange of a filter, or not to perform such cleaning and exchange. Accordingly, clogging of piping and a filter can be suppressed.

In the second aspect of the present invention, due to the reverse purge gas which is introduced from the concentration measurement part of the piping to the filter, it is possible to blow away dust which is collected by a filter and piping to the side of the kneading chamber. Accordingly, it is possible to measure the oxygen concentration in a kneading chamber stably without performing operations such as piping cleaning and exchange of a filter, while suppressing clogging of the piping and the filter.

### BRIEF DESCRIPTION OF THE DRAWINGS

FIG. 1 shows a schematic view of a Banbury-mixer which is one example of a kneading apparatus to which the first aspect of the present invention is applied.

FIG. 2 shows a flowchart which is used to explain a drive controlling method of a kneading apparatus to which the present invention is applied.

FIG. 3 is a graph which shows an initial purge, and shows the results obtained by measurement of: variations of a purge flow rate of an inert gas, which is introduced in a kneading chamber sealed after exposure to air without feeding a material to be kneaded in the chamber; and variations of the oxygen concentration in the kneading chamber which is measured by the oxygen analyser.

FIG. 4 is a graph which shows an initial batch, and shows the results obtained by measurement of: variations of a purge flow rate of an inert gas, which is introduced in a kneading chamber sealed after a material to be kneaded is charged in the chamber subsequent to exposure to air; and variations of the oxygen concentration in the kneading chamber which is measured by the oxygen analyser.

FIG. 5 is a graph which shows the results obtained by measurement of: variations of a purge flow rate of an inert gas introduced in a kneading chamber for second and following batches, wherein the inert gas is introduced at a flow rate which is corrected by arithmetic operation performed over again since variations of the concentration in a previous batch are not included in the allowable range; and variations of the oxygen concentration in the kneading chamber which is measured by the oxygen analyser.

FIG. 6 is a graph which shows the results obtained by measurement of variations of a purge flow rate of an inert gas which is introduced in a kneading chamber for a batch, in which arithmetic operation is stopped; and variations of the oxygen concentration which is measured by the oxygen analyser (measurement of zero gas).

FIG. 7 is a graph which shows the results obtained by measurement of variations of a purge flow rate of an inert gas introduced in a kneading chamber for batch processing performed in succession in Examples; and variations of the oxygen concentration measured by the oxygen analyser.

FIG. 8 is a schematic view of a Banbury-mixer, which is one example of a kneading apparatus to which the second aspect of the present invention is applied.

FIG. 9 shows variation of the Banbury-mixer shown in FIG. 8, and is a schematic view wherein a two-way valve is used instead of the four-way valve.

FIG. 10 shows variation of the Banbury-mixer shown in FIG. 8, and is a schematic view wherein a three-way valve is used instead of the four-way valve.

FIG. 11 shows variation of the Banbury-mixer shown in FIG. 8, and is a schematic view which shows a case wherein a dust collector and a filter are connected to remove dust.

### BEST MODE FOR CARRYING OUT THE INVENTION

Hereinafter, a kneading apparatus according to the present invention is explained in detail with reference to the drawings.

Examples are explained concretely below to make clear the intent of the present invention, but it should be understood that they are not to be considered as limiting, unless noted otherwise. Additions, omissions, substitutions and other modifications with respect to position, number, shape or the like can be made without departing from the scope of the present invention. It should be understood that the present invention is not limited to the explanation described below, and only limited by the range of claims attached. Furthermore, between the two embodiments, preferable examples, preferable conditions and the like may be shared, or exchanged with each other.

(Kneading APPARATUS OF THE FIRST ASPECT)

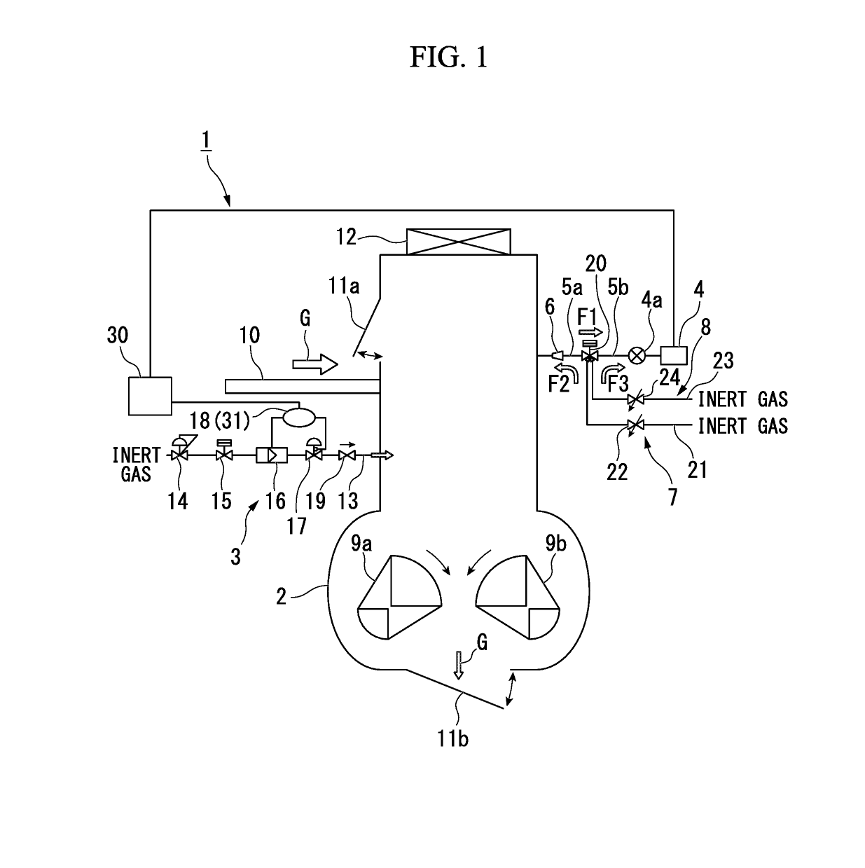

A kneading apparatus to which the first aspect of the present invention is applied is, for example, a Banbury-mixer 1 as shown in FIG. 1, which is preferably used when a rubber product such as tires is manufactured. In such a mixer, additives and compounding agents, such as sulfur, carbon black, oil, antioxidant and a vulcanization accelerator, are added to rubber, which is used as a raw material of the rubber product, and kneaded as a material to be kneaded G in a heated state and/or a pressurized state. Concretely, as shown in FIG. 1, the Banbury mixer 1 is equipped with: a kneading chamber 2 which kneads the material G; a first gas feed line which introduces an inert gas to the kneading chamber, that is, a first gas feed part (first gas feed means) 3, an oxygen analyser which measures the oxygen concentration in the kneading chamber 2, that is, oxygen measurement part (concentration measurement means) 4;

pipings 5a and 5b which introduce an atmospheric gas in the kneading chamber to the oxygen analyser 4;

a filter 6 which collects dust and the like included in the atmospheric gas flowing in the piping 5a which exists at the inlet side (one side),

a second gas feed line (second gas feed means) 7 which introduces a reverse purge gas via the piping 5b, which exists at the outlet side (the other side), from the side of the oxygen analyser 4; and

a third gas feed line (third gas feed means) 8 which introduces zero gas which does not include contamination materials into the oxygen analyser 4.

The kneading chamber 2 has a sealed structure having the construction wherein kneading is performed by adding a large shearing force to the material to be kneaded G, while rotating a pair of rotors 9a and 9b, which are provided in the chamber, in the opposite directions to each other. Furthermore, an openable/closable injection door 11a is provided at the side surface of the upper part of the kneading chamber 2, and is used to feed a material to be kneaded G which is conveyed by a belt conveyor 10 or the like and is not kneaded yet. On the other hand, an openable/closable discharge door 11b is provided at the lower part of the kneading chamber 2, and is used to discharge the material G which has been kneaded to the outside. Furthermore, a dust collector 12 is provided to the upper part of the kneading chamber 2, and is used to collect dust or the like existing in the kneading chamber 2.

The first gas feed line 3 is a line which is used to introduce an inert gas such as nitrogen and carbon dioxide to the kneading chamber 2 via the first introduction pipe 13 which is connected to the kneading chamber 2. The line includes, between the kneading chamber 2 and a gas supply source (not shown) which supplies an inert gas, a pressure-regulating valve (pressure reducing valve) 14 which controls pressure of an inert gas which flows in the first introduction pipe 13;

a shut-off valve (electromagnetic valve) 15 which is configured to open and close the first introduction pipe 13;

a flowmeter (FT) 16 which measures a flow rate of an inert gas which flows in the first introduction pipe 13;

a flow rate-controlling valve (FCV) 17 which controls a flow rate of an inert gas which flows in the first introduction pipe 13;

a flow rate controller (FIC) 18 which controls a flow rate of an inert gas which flows in the first introduction pipe 13, wherein the flow rate is controlled by the flow rate-controlling valve 17 based on the measurement result of the flowmeter 16; and a check valve 19 which prevents an atmosphere in the kneading chamber 2 from flowing into the first introduction pipe 13.

The oxygen analyser 4 measures the oxygen concentration within an atmospheric gas, when the atmospheric gas in the kneading chamber 2 is aspirated by a pump 4a via the pipings 5a and 5b connected to the kneading chamber 2. The pipings 5a and 5b are structured as measurement lines which introduce into the oxygen analyser 4 the atmospheric gas from which dust and the like have been removed by the filter 6. The filter 6 is connected to the pipings 5a and 5b, and is provided as an interchangeable part. Here, the filter 6 used herein is not particularly limited, and conventionally known products can be used in so far as dust included in the atmospheric gas in the kneading chamber 2 such as sulfur can be collected by the filter.

Furthermore, between the piping 5a existing at the inlet side and the piping 5b existing at the outlet side, a four-way valve (switching means) 20 is provided. The four-way valve 20 switches: a first flow F1 wherein an atmospheric gas in the kneading chamber 2 proceeds to the oxygen analyser 4 via the piping 5a existing at the inlet side; a second flow F2 wherein a reverse purge gas which is introduced from the second gas feed line 7 proceeds to the filter 6 via the piping 5a existing at the inlet side; and a third flow F3 wherein zero gas which is introduced from the third gas feed line 8 proceeds to the oxygen analyser 4 via the piping 5b existing at the outlet side.

The second gas feed line 7 is a reverse purge line which introduces a reverse purge gas toward the piping 5a, which exists at the inlet side, via the second introduction pipe 21 connected to the four-way valve 20. The gas feed line 7 has a flow rate-controlling valve 22, which controls a flow rate of a reverse purge gas flowing in the second introduction pipe 21 and exists between the four-way valve 20 and a gas supply source (not shown) which supplies an inert gas, for example, such as nitrogen or carbon dioxide as the reverse purge gas.

The third gas feed line 8 is a zero gas feed line which introduces zero gas toward the piping 5b existing at the outlet side, via the third introduction pipe 23 which is connected to the four-way valve 20. The inert gas such as nitrogen and carbon dioxide can be cited as the zero gas, and the third gas feed line 8 has, between the four-way valve 20 and a gas supply source (not shown) which supplies the inert gas, a flow rate-controlling valve 24 which controls a flow rate of zero gas flowing in the third introduction pipe 23.

The material G which is conveyed by the belt conveyor 10 is fed in the kneading chamber 2. At this time, it is preferable that the injection door 11a be opened immediately before the material G is fed in the kneading chamber 2 and closed immediately after the material is fed in, so that an increase of the oxygen concentration in the kneading chamber, which is caused by atmospheric exposure, is suppressed.

Furthermore, it is also acceptable that an inert gas be introduced in the kneading chamber 2 via the first gas feed line 3 so that the oxygen concentration in the kneading chamber 2 becomes equal to or less than the ignition limit, while the injection door 1 la and the discharge door 1 lb of the kneading chamber 2 are closed, and then, the material G be fed in the kneading chamber 2 while introducing an inert gas to the chamber.

After the material G is fed in the kneading chamber 2, the material G is plasticized while performing heating and/or pressurizing, and then kneaded by adding a large shearing force to the material by a pair of rotors 9a and 9b which rotate in the opposite directions to each other, while the plasticized state of the material is maintained.

Furthermore, after kneading, the discharge door 11b is opened to discharge the material G to the outside. Here, in the kneading operation performed by the Banbury mixer 1, operation management of the mixer is performed by confirming the state of the material G in the kneading chamber 2, while the temperature in the kneading chamber 2 and the current value of a motor which drives rotors 9a and 9b and the like are measured.

In the Banbury mixer 1, an inert gas is introduced in the kneading chamber 2 via the first gas feed line 3 so that the oxygen concentration in the kneading chamber 2 becomes a target value, while the injection door 11a and the discharge door 11b of the kneading chamber 2 are closed. As a concrete target oxygen concentration in the kneading chamber 2, it is preferable that the oxygen concentration in the kneading chamber 2 do not exceed 10 volume %, which is the ignition limit. On the other hand, when the oxygen concentration in the kneading chamber 2 becomes too low due to an increase of an amount of the inert gas, problems such as deterioration of a material to be kneaded G (rubber and the like) may be caused. Accordingly, it is preferable that the lower limit of the oxygen concentration in the kneading chamber 2 be set to a value which does not cause such problems (for example, to 4 volume % or more).

Furthermore, in the Banbury mixer 1, the atmospheric gas from which dust and the like has been remover by the filter 6 is introduced into the oxygen analyser 4 via the piping 5b, while aspirating the atmospheric gas in the kneading chamber 2 by a pump 4a via the piping 5a which is connected to the kneading chamber 2. The oxygen concentration of the introduced atmospheric gas is measured by the oxygen analyser 4. Furthermore, introduction of an inert gas from the first gas feed line 3 into the kneading chamber 2 is controlled based on the measured value, so that the inside of the kneading chamber 2 achieves the target oxygen concentration described above.

In order to perform the aforementioned control, the Banbury mixer 1 is equipped with an arithmetic operation section (operation means) 30 which performs arithmetic calculation to make the inside of the kneading chamber 2 achieve the target oxygen concentration; and a control section (control means) 31 which controls the gas introduction line 3 based on the arithmetic operation result obtained by the arithmetic operation section 30.

Among them, the arithmetic operation section 30 may be, for example, a process computer such as a programmable logic controller (PLC), and is electrically connected with the oxygen analyser 4. On the other hand, the control section 31 is, for example, a mass flow controller such as a flow indication controller (FIC), and the flow rate-controlling device (FIC) 18 as the control section 31 is electronically connected with the arithmetic operation section 30 in the present embodiment.

Furthermore, in the Banbury mixer 1, the arithmetic operation section 30 performs arithmetic operation to set the inside of the kneading chamber 2 to the target oxygen concentration while comparing the oxygen concentration which is actually measured by the oxygen analyser 4 and the target oxygen concentration which is predicted in advance. Based on the arithmetic operation results, the control section 31 controls a purge flow rate and purge time of an inert gas, which is introduced in the kneading chamber 2 from the gas introduction line 3.

Furthermore, in the Banbury mixer 1, a batch type system is used wherein a kneading step, in which a material to be kneaded G is fed, kneaded and discharged as one batch, is repeated to treat plural batches. The aforementioned plural batches mean two or more batches, and preferably three or more batches. The upper limit of the batch number is not particularly limited, and can be selected optionally. The arithmetic operation section 30 repeats arithmetic operations for each batch, and the control section 31 controls a purge flow rate and purge time of an inert gas which is introduced in the kneading chamber 2 from the first gas introduction line 3.

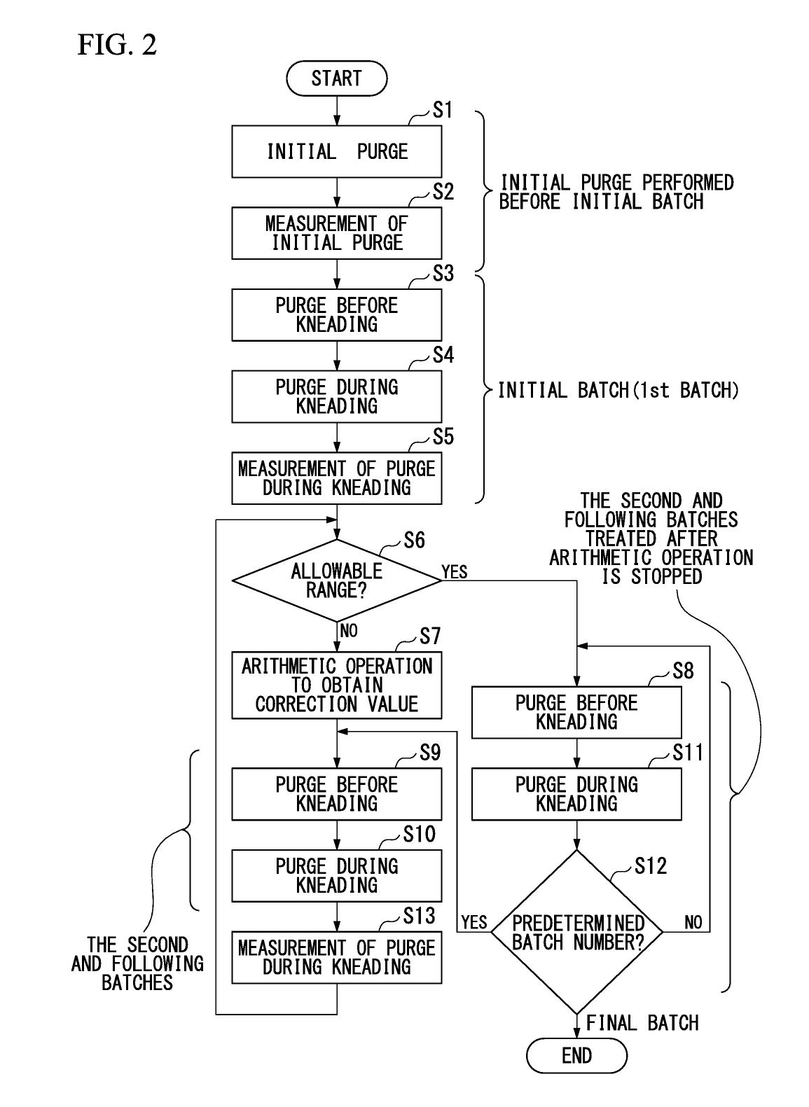

Hereinafter, an example of a drive controlling process which maintains stably the inside of the kneading chamber 2 to a target oxygen concentration using the Banbury mixer 1 to which the present invention is applied is explained concretely based on a flowchart shown in FIG. 2.

Here, in FIG. 2, a purge during kneading step and a purge during kneading measurement step subsequent to the kneading step are shown in turn. However, it is preferable that measurement of the purge during kneading be performed while the purge during kneading step is performed.

(Step S1)

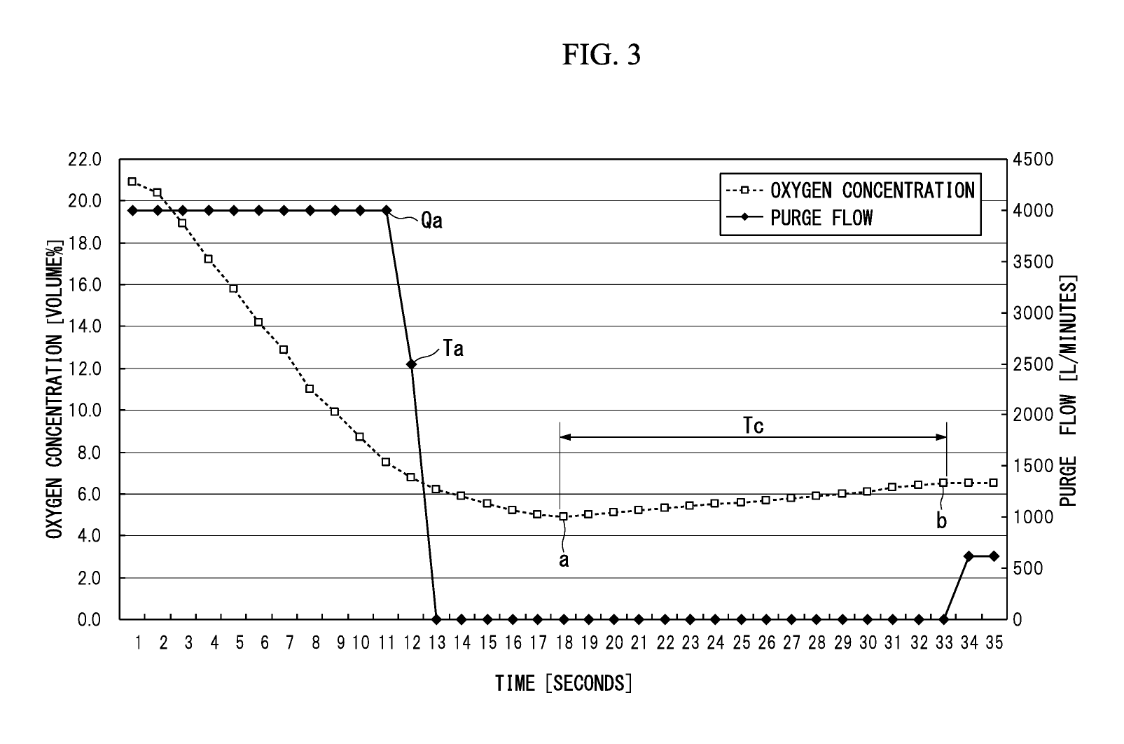

In the Banbury mixer 1 to which the present invention is applied, at first, the process proceeds to a step Si (initial purge step) shown in FIG. 2. In the step, before initial purge is started in which batch processing is performed, initial purge is performed without performing such batch processing, in order to obtain a standard value which is required for making the inside of the kneading chamber 2 achieve the target oxygen concentration. That is, a material to be kneaded G is not fed in said initial purge. Concretely, for example, as shown in FIG. 3, before a material G is fed in the kneading chamber 2, the oxygen concentration inside the kneading chamber 2 is set to the oxygen concentration of air (about 20.9%) by opening the injection door 11a so that the inside of the kneading chamber 2 is exposed to air. In the present example, measurement of the oxygen concentration is continuously performed except for an arithmetic operation-stopping step described below, in so far as the specific explanation is not provided. However, it is also possible to interrupt the measurement as necessary at the time point where measurement of the oxygen concentration is not needed.

Here, a solid line shown in FIG. 3 represents a purge flow rate of an inert gas which is introduced in the kneading chamber 2, and a broken line shown in FIG. 3 represents the oxygen concentration in the kneading chamber 2 which is measured every one second.

After exposure to air, the inside of the kneading chamber 2 is put into a sealed state without feeding a material G, and an inert gas is introduced in the kneading chamber 2 via the first gas feed line 3, while the oxygen concentration in the chamber is measured by the oxygen analyser 4. At this point, the control section 31 introduces an inert gas into the kneading chamber 2 from the first gas feed line 3, while a flow rate of the introduced inert gas (a flow rate of an initial purge) is set to the predetermined fixed value for a period of time (initial purge time, which is a value obtained from the formula (2) shown below) until the oxygen concentration in the kneading chamber 2 arrives at the target value (for example, value equal to or less than ignition limit). Accordingly, the oxygen concentration in the kneading chamber 2 decreases based on the feed amount of an inert gas (a flow rate of initial purge×initial purge time).

Hereinafter, initial purge time Ta is obtained. The target oxygen concentration in the kneading chamber 2 can be represented by the general formula (1) shown below, when it is assumed that an atmospheric gas in the kneading chamber 2 which is obtained after the exposure to air and an inert gas which is introduced in the kneading chamber 2 are completely mixed.

Xa=X0*exp^{-(Qa/V0)*Ta} (1)

In the formula (1), Qa represents an initial purge flow rate (NL/minute), Ta represents initial purge time (second), Xa represents the (target) oxygen concentration (volume %) in the kneading chamber 2 which is measured after an inert gas is introduced, Xo represents the oxygen concentration (volume %) in the kneading chamber 2 which is measured before an inert gas is introduced, and VO represents the inner volume (L) of the kneading chamber 2.

Here, in the present invention, “N” of the aforementioned NL/minute means “Normal”, and NL/minute may be represented simply by L/minute.

Accordingly, based on the aforementioned formula (1), initial purge time Ta can be obtained by the following formula (2).

Ta=−V0/Qa*In(Xa/X0) (2)

(Step S2)

Subsequently, in the Banbury mixer 1, the process proceeds to a step S2 shown in FIG. 2 (initial purge measurement step). In the step, introduction of the inert gas into the kneading chamber 2 performed in the initial purge is stopped, and the measurement of variations of the oxygen concentration (initial purge measurement) is performed by the oxygen analyser 4 during the fixed period (initial purge measurement time). Here, as shown in a graph of FIG. 3, the oxygen concentration in the kneading chamber 2 gradually increases after the introduction of the inert gas is stopped.

The reason for the increase of the oxygen concentration is that outside air is introduced from a gap existing in the kneading chamber 2, since negative pressure is generated in the kneading chamber 2 due to operation of the dust collector.

By an arithmetic operation section 30, the lowest value (measured value a shown in FIG. 3) and the uppermost value (measured value b show in FIG. 3) of the oxygen concentration during the initial purge measurement time are obtained based on the aforementioned measurement result of the oxygen concentration which is measured by the oxygen analyser 4, and the increased value of the oxygen concentration (b-a, or Xc-Xb) during the initial purge measurement time is obtained by arithmetic operation.

Furthermore, by the arithmetic operation section 30, a flow rate of an inert gas which can offset the increment of the oxygen concentration in the initial purge measurement time (initial purge predicted flow rate Qc) is obtained by operation based on the aforementioned data.

Here, the initial purge predicted flow rate Qc (NL/minute) can be obtained from the formula (3) shown below.

Qc=V0/Tc*In(Xc/Xb) (3)

(∵Xc=Xb*exp−(Qc/V0)*Tc)

Here, in the formula (3), Tc represents initial purge measurement time (second), Xb represents a lowest value (volume %) of the oxygen concentration during the initial purge measurement time, and Xc represents an uppermost value (volume %) of the oxygen concentration during the initial purge measurement time.

According to the above operation, four values can be obtained or be set which are used as standard values to set the inside of the kneading chamber 2 to the target oxygen concentration Xa. That is, (i) an initial purge flow rate Qa (set to a fixed value), (ii) initial purge time Ta, (iii) an initial purge predicted flow rate Qc which is used as a standard value to maintain the inside of the kneading chamber 2 at the target oxygen concentration Xa as it is while kneading (a flow rate of an inert gas which is predicted based on the measurement and arithmetic operation in the initial purge and can offset the rising of oxygen concentration), and (iv) initial purge measurement time Tc (set to the fixed value).

(Step S3)

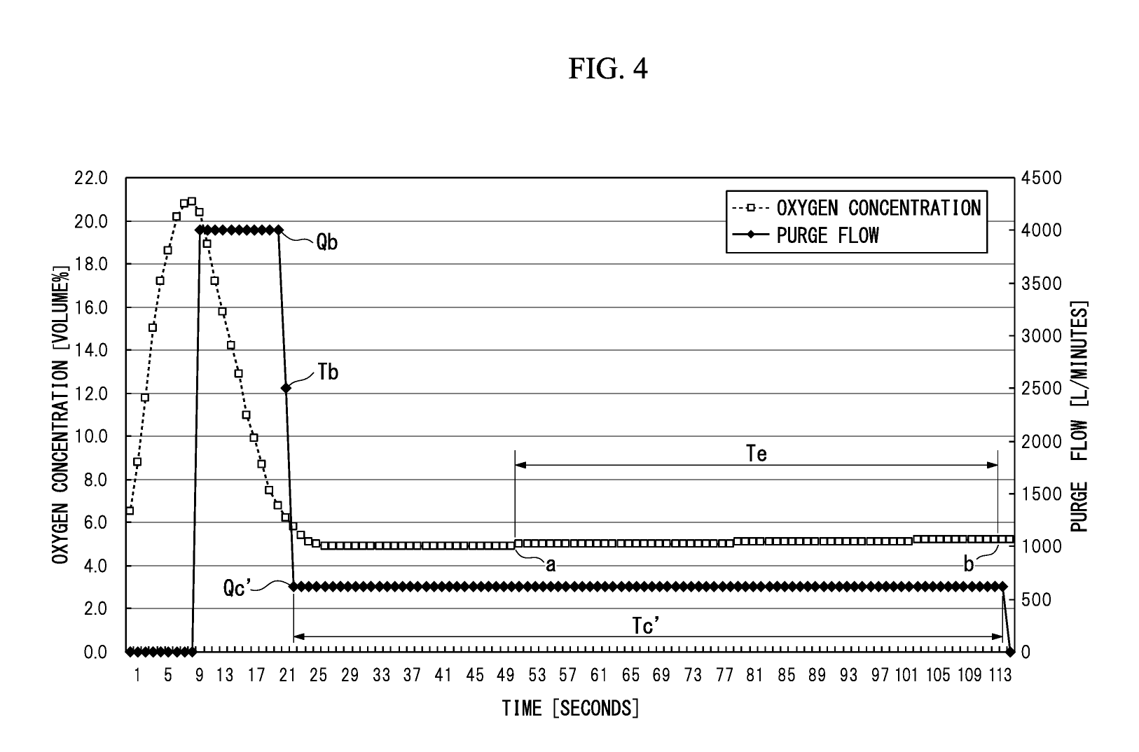

Subsequently, in the Banbury mixer 1, the process proceeds to an initial batch shown in FIG. 2. That is, a step S3 (purge before kneading step) shown in FIG. 2 is performed. In the step, a purge before kneading step is performed wherein the inside of the kneading chamber 2 is set to the target oxygen concentration Xa before kneading of the initial batch is started. Concretely, for example, as shown in the left part of a graph of FIG. 4, when a material G is introduced in the kneading chamber 2, the injection door 11 a is opened to expose the inside of the kneading chamber 2 to air, and the oxygen concentration in the kneading chamber 2 achieves the oxygen concentration of air (about 20.9%).

Here, a solid line shown in FIG. 4 represents a purge flow rate of an inert gas which is introduced in the kneading chamber 2, and a broken line shown in FIG. 4 represents the oxygen concentration in the kneading chamber 2.

In the present invention, since the introduction of an inert gas to the kneading chamber 2 is started via the first gas feed line 3 after the exposure to air, the inside of the kneading chamber 2, to which an inert gas has not been introduced, can be always set to the identical oxygen concentration which is used as an identical standard (oxygen concentration of air), in each batch.

From the opened injection door 11a, a material G is fed. Subsequently, after the material G is fed, the inside of the kneading chamber 2 is put in a sealed state. Then, a purge before kneading step is performed wherein an inert gas is introduced in the inside of the kneading chamber 2 via the first gas feed line 3 while measuring of the oxygen concentration is maintained by the oxygen analyser 4.

Here, the control section 31 introduces an inert gas into the kneading chamber 2 from the first gas feed line 3, while a flow rate of the introduced inert gas (a flow rate of purge before kneading Qb) is set to a predetermined fixed value for a period of time (purge before kneading time Tb) until the inside of the kneading chamber 2 arrives at the target value Xa (the predetermined target value).

The purge before kneading time Tb can be determined by the formula (5) shown below, and a fixed value is used as the flow rate of purge before kneading Qb. It is preferable that the value of the flow rate Qb be the same as that of the flow rate Qa.

The inner volume V (L) of the kneading chamber 2 to which the material to be kneaded G has been fed can be represented by the formula (4) shown below.

V=V0−kg*Vg (4)

Here, in the formula (4), Vg represents the volume (L) of a material to be kneaded G, and kg represents a space coefficient of the material G.

Accordingly, purge before kneading time Tb (second) can be obtained by the formula (5) based on the formulae (1) and (4).

Tb=−V/Qb*In(Xa/X0) (5)

In the Banbury mixer 1 to which the present invention is applied, before the introduction of an inert gas is performed in the purge before kneading step, arithmetic operation is performed by the arithmetic operation section 30 to obtain the aforementioned purge before kneading time Tb. Furthermore, purge before kneading (introduction of an inert gas) is performed, while the control section 31 controls a purge flow rate and purge time of an inert gas, which is introduced in the kneading chamber 2 from the first gas introduction line 3, based on the results of the arithmetic operation. That is, the control section 31 introduces an inert gas into the kneading chamber 2 from the first gas feed line 3, while a flow rate of the introduced inert gas (a purge before kneading flow rate Qb) is set to a predetermined fixed value for a period of time (purge before kneading time Tb) until the oxygen concentration in the kneading chamber 2 arrives at the target oxygen concentration Xa as described above. Accordingly, the inside of the kneading chamber 2 can be set to the target oxygen concentration Xa before kneading of the material G is started.

(Steps S4 and S5)

Subsequently, in the Banbury mixer 1, the process proceeds to a step S4 shown in FIG. 2 (purge during kneading step). In the step, kneading of the material G is started after the inert gas is introduced to the kneading chamber 2 in the purge before kneading step, while a purge during kneading is performed to prevent an increase of the oxygen concentration in the kneading chamber 2 during kneading. Concretely, as shown in a graph of FIG. 4, an inert gas is introduced in an amount, which is determined by arithmetic operation, into the kneading chamber 2 via the first gas feed line 3, while the oxygen concentration in the chamber 2 is measured by the oxygen analyser 4 while kneading. The kneading time can be optionally selected, and may be used in the arithmetic operation.

At this time, the control section 31 introduces an inert gas in the kneading chamber 2 from the first gas introduction line 3, while controlling the flow rate of the introduced inert gas (a purge during kneading flow rate Qc′) for a period of time (purge during kneading time Tc′) wherein the material G is kneaded.

A volume ratio λ, of the kneading chamber 2 before and after the material G is fed can be represented by the following formula (6).

λ=V/V0 (6)

Accordingly, a purge during kneading flow rate Qc′ (NL/minute) can be obtained from the formula (7) shown below, based on the initial purge predicted flow rate Qc which is obtained by the formula (3) as a standard value, the formula (6) and purge during kneading time Tc′.

Qc′=Qc*k (7)

Here, Qc in the above formula (7) is a value wherein Tc in the formula (3) is converted to Tc′.

In the Banbury mixer 1 of the present embodiment, before an inert gas is introduced in the purge during kneading step, arithmetic operation is performed by the arithmetic operation section 30 to obtain the aforementioned purge during kneading flow rate Qc′. Furthermore, based on the results of the arithmetic operation, purge during kneading (introduction of an inert gas) is performed by the control section 31, while a purge flow rate and purge time of an inert gas are controlled by the section wherein the inert gas is introduced in the kneading chamber 2 by the first gas introduction line 3.

That is, the control section 31 introduces an inert gas into the kneading chamber 2 from the first gas feed line 3, while the flow rate of the inert gas (a purge during kneading flow rate Qc′) is set to a fixed value while kneading is performed for a period (purge during kneading time Tc′) as described above. Due to the method, the inside of the kneading chamber 2 can be maintained at the target oxygen concentration Xa (predetermined target value).

In the Banbury mixer 1, a step S5 (purge during kneading measurement step) shown in FIG. 2 is performed while the purge during kneading step is performed. That is, as shown in the right part of a graph of FIG. 4, the aforementioned purge during kneading is performed, and the step S5 is started to measure the variation of the oxygen concentration by the oxygen analyser 4 (referred to as purge during kneading measurement) when the oxygen analyser 4 confirms that the oxygen concentration in the kneading chamber 2 arrives at the lowest value during the kneading. The time between when the oxygen concentration arrives at the lowest value and when the oxygen concentration arrives at the uppermost value is shown as purge during kneading measurement time Te, wherein the uppermost value is obtained after the oxygen concentration arrives at the lowest value and subsequently begins to increase.

(Step S6)

Subsequently, the process proceeds to a step S6 (a step of confirming an allowable range) shown in FIG. 2. In this step, the oxygen concentration which is actually measured by the oxygen analyser 4 in the step S5 and a predetermined concentration range (previously set) which includes target oxygen concentration Xa are compared with each other, and it is confirmed whether or not the measured oxygen concentration is included in the predetermined concentration range, that is, whether or not the measured oxygen concentration is included in an allowable range. The allowable range, that is, the predetermined concentration range which includes the target oxygen concentration Xa can be optionally selected if necessary.

Concretely, the arithmetic operation section 30 compares the predetermined concentration range, which includes the target oxygen concentration Xa, and the uppermost and lowest values of the oxygen concentration during the purge during kneading time Tc′, and confirms whether or not each of the uppermost value and the lowest value of the oxygen concentration is included in the predetermined concentration range. Furthermore, when the uppermost value or the lowest value of the oxygen concentration is not included in the predetermined concentration range, the process proceeds to a step S7 (arithmetic operation to obtain correction value step) shown in FIG. 2 described above. On the other hand, when they are included in the predetermined concentration range, the process proceeds to a step S8 (purge before kneading step which is performed for the second and following batches and performed after arithmetic operation is stopped).

(Step S7)

In a step S7 (arithmetic operation to obtain correction value step) shown in FIG. 2, before a subsequent batch is treated, a flow rate of an inert gas, which can offset the concentration difference, is obtained based on the comparison result in the steps S5 and S6 wherein the predetermined target oxygen concentration and the oxygen concentration measured by the oxygen analyser 4 are compared. The obtained value is used as a correction value to maintain the inside of the kneading chamber 2 to the target oxygen concentration Xa as it is during kneading.

Concretely, in the previous steps performed, the lowest value (measured value a shown in FIG. 4) and the uppermost value (measured value b show in FIG. 4) of the oxygen concentration in the purge during kneading time (Tc′) of the initial batch are obtained by the arithmetic operation section 30 based on the results of measuring the oxygen concentration, which is measured by the oxygen analyser 4, and furthermore, the increment of the oxygen concentration (b-a) during the purge during kneading measurement time is also obtained by operation thereof

In the step S7, the arithmetic operation section 30 performs arithmetic operation to obtain a flow rate of an inert gas (a purge during kneading correction flow rate q) which offsets the increased value of the oxygen concentration increased during the purge during kneading measurement time.

Here, the purge during kneading correction flow rate q (NL/minute) can be obtained by the following formula (8).

q=−V/Te*In(Xe/Xd) (8)

(∵Xe=Xd*exp^{-(q/V)*Te})

Here, in the formula (8), Te represents purge during kneading measurement time (second), Xd represents a lowest value of the oxygen concentration (measured value a) (volume %) in the purge during kneading time Tc′, and Xe represents an uppermost value of the oxygen concentration (measured value b) (volume %) in the purge during kneading time Tc′.

In this way, the purge during kneading correction flow rate q can be obtained which is used as a correction value to maintain the inside of the kneading chamber 2 to the target oxygen concentration in the purge during kneading step in a subsequent batch, when the concentration exceeds the allowable range in the initial and following batches.

Here, calculation performed to obtain the purge during kneading correction flow rate q (step S7) may be performed before the step (step S6) wherein whether or not the oxygen concentration is included in the allowable range is confirmed.

(Step S9)

Next, in the Banbury mixer 1, the second batch or later is treated as shown in FIG. 2. That is, the process proceeds to a step 9S shown in FIG. 2 (purge before kneading step which is carried out after the variation of the oxygen concentration of the initial batch exceeds the allowable range). In this step, purge before kneading is performed for the second batch and the following batches, to set the inside of the kneading chamber 2 to the target oxygen concentration Xa before kneading is started in each batch.

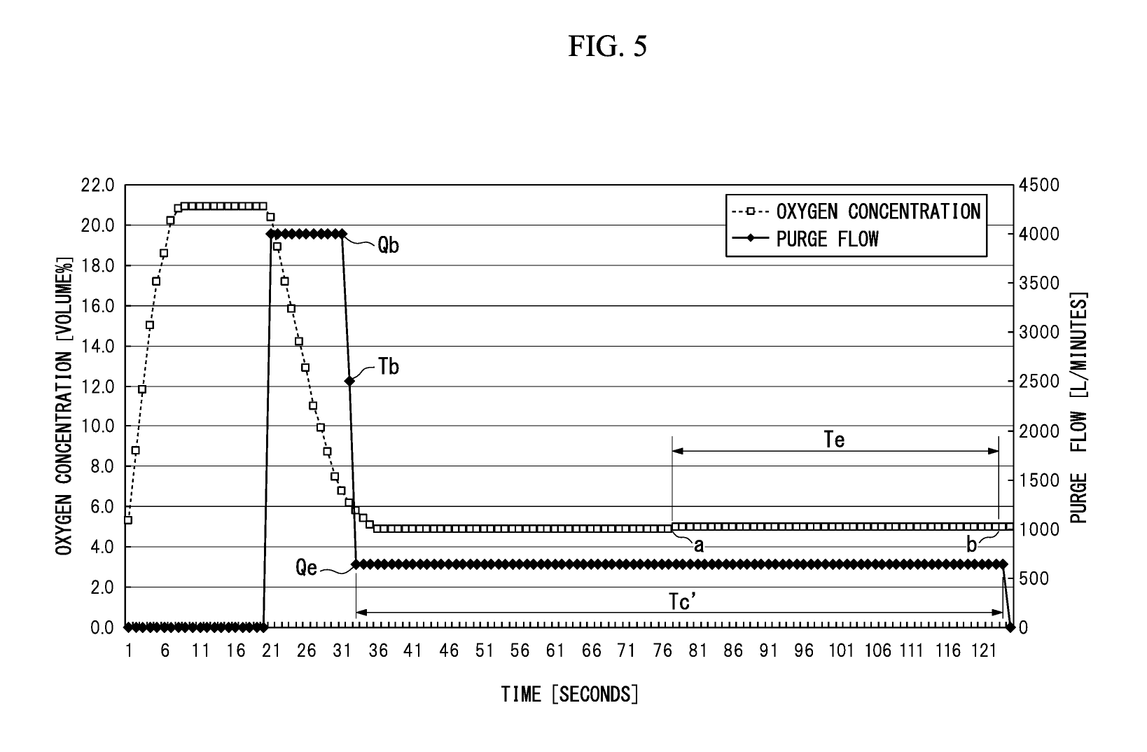

Concretely, as shown in a graph of FIG. 5, when the second batch or later is treated, at first, before a material G is fed in the kneading chamber 2, the oxygen concentration inside the kneading chamber 2 is set approximately to the oxygen concentration of air (about 20.9%) by opening the injection door 11a so that the inside of the kneading chamber 2 is exposed to air.

Here, a solid line shown in FIG. 5 represents a purge flow rate of an inert gas which is introduced in the kneading chamber 2, and a broken line shown in FIG. 5 represents the oxygen concentration in the kneading chamber 2.

After a material G is fed, the inside of the kneading chamber 2 is set to a sealed state, and an inert gas is introduced in the kneading chamber 2 via the first gas feed line 3 to perform purge before kneading, while the oxygen concentration in the chamber is measured by the oxygen analyser 4.

Here, the control section 31 can control similar to that of the step S3. Concretely, an inert gas is introduced into the kneading chamber 2 from the first gas feed line 3, while a flow rate of the introduced inert gas (a purge before kneading flow rate Qb) is set to the fixed value for a period of time until the inside of the kneading chamber 2 arrives at the target value Xa (purge before kneading time Tb). That is, in the purge before kneading of the second batch or later, the purge before kneading is similarly performed such that the control section 31 controls a purge flow rate and purge time of an inert gas, which is introduced into the kneading chamber 2, by the first gas feed line 3 based on the results of the arithmetic operation, which is performed by the arithmetic operation section 30 for the purge before kneading step of the initial batch in the step S3.

Accordingly, the inside of the kneading chamber 2 can be set to the target oxygen concentration Xa before kneading of a material G is started in the second or later batches.

(Steps S10 and S13)

Subsequently, in the Banbury mixer 1 of the embodiment, the process proceeds to a step S10 (a purge during kneading step performed for a subsequent batch which is treated after the variation of the oxygen concentration of the previous batch exceeds the allowable range) shown in FIG. 2. Kneading of the material G is started, and purge during kneading is also performed to suppress an increase of the oxygen concentration in the kneading chamber 2 during kneading.

Concretely, after the purge before kneading is performed, the second or later batch is treated such that an inert gas is introduced into the kneading chamber 2 in an amount, which is determined by arithmetic operation performed in the step S7, via the first gas feed line 3, while kneading is performed and the oxygen concentration in the chamber 2 is measured by the oxygen analyser 4, as shown in the center and the right part of a graph of FIG. 5.

At this time, the control section 31 introduces an inert gas into the kneading chamber 2 from the first gas introduction line 3, while a flow rate of the introduced inert gas (a subsequent batch purge during kneading flow rate Qe: it may be described as a purge during kneading flow rate which is used for a batch which is treated after a previous batch wherein the variation of the oxygen concentration of the previous batch exceeds the allowable range) is set to a fixed value for a period of time wherein a material to be kneaded G is kneaded (purge during kneading time Tc′). In the example, the purge during kneading time Tc′ is the same as the purge during kneading time Tc′ used in the previous batch.

Here, a subsequent batch purge during kneading flow rate Qe (NL/minute) can be obtained by the following formula (9) based on the purge during kneading correction flow rate q and the formula (7).

Qe=Qc′(or Qe′)−q (9)

Here, Qe′ shown in the formula (9) represents a purge during kneading flow rate of the previous batch. That is, in the third and following batches, Qe′ which is the purge flow rate of the previous batch is used to obtain a purge during kneading flow rate Qe of the subsequent batch. That is, in the third and following batches, the previous batch purge during kneading flow rate Qe′ is used to obtain the subsequent batch purge during kneading flow rate Qe.

In the Banbury mixer 1, when either of the lowest value and the uppermost value of the oxygen concentration in the previous batch is not included in the allowable range, the arithmetic operation section 30 performs arithmetic operation to obtain the subsequent batch purge during kneading flow rate Qe shown in the formula (9), before an inert gas is introduced in the purge during kneading step. Then, based on the result of the arithmetic operation, a purge during kneading is performed in the step S10, while controlling a purge flow rate and purge time of an inert gas, which is introduced in the kneading chamber 2 via the first gas introduction line 3, by the controlling part 3. That is, the control section 31 introduces an inert gas into the kneading chamber 2 from the first gas feed line 3, while the flow rate of the inert gas (a subsequent batch purge during kneading flow rate Qe) is set to a fixed value while kneading is performed (purge during kneading time Tc′) as described above. Due to the method, the inside of the kneading chamber 2 can be maintained at the target oxygen concentration Xa during kneading.

Furthermore, in the Banbury mixer 1, a step S13 (purge during kneading measurement step) shown in FIG. 2 is performed in the purge during kneading step. In the step S13, measurement of the lowest value and the uppermost value of the oxygen concentration by the oxygen analyser 4 and calculation of the purge during kneading measurement time Te can be performed similar to that of the aforementioned step S5.

Thereafter, the process is returned to the step S6 shown in FIG. 2. That is, whether or not the variation of the oxygen concentration of the step 513 is included in the allowable range is judged.

(Step S8)

On the other hand, when the oxygen concentration in the step S6 is included in the allowable range, the process proceeds to a step S8 shown in FIG. 2. In the step S8 (purge before kneading step performed after arithmetic operation is stopped), the arithmetic operation which is performed to obtain the purge during kneading correction flow rate q is stopped in the subsequent (second) batch and batches following said subsequent batch, that is, the arithmetic operation is stopped in the batches which are treated in the present step. When the arithmetic operation used for obtaining the correction flow rate is stopped, it is not necessary to measure the oxygen concentration. Furthermore, after the arithmetic operation is stopped, a purge before kneading is performed based on the conditions used in the previous batch before kneading is started for a subsequent batch, so that the inside of the kneading chamber 2 is set to the target oxygen concentration Xa.

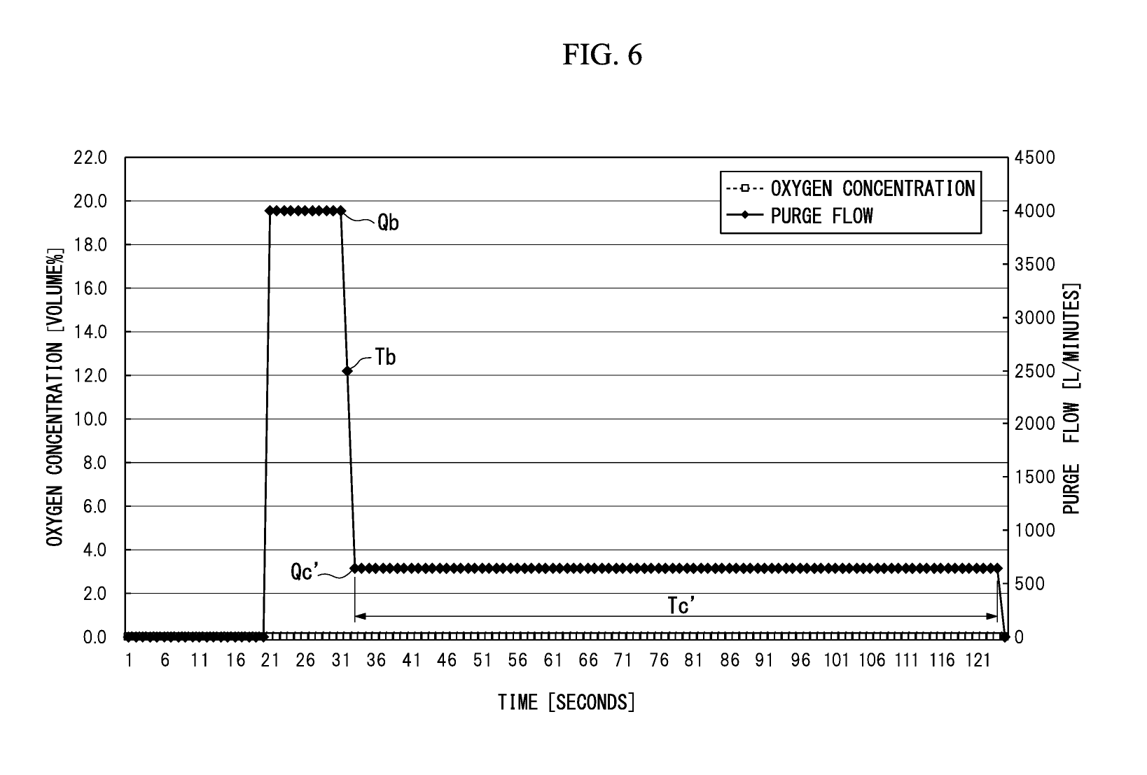

Concretely, in the batches which are treated after the arithmetic operation is stopped, the oxygen analyser 4 does not measure the oxygen concentration in the kneading chamber, for example, as shown in FIG. 6. However, the injection door 11a is opened before a material G is fed in the kneading chamber 2, and therefore, the inside of the kneading chamber 2 is exposed to air so that the inside is approximately set to the oxygen concentration of air (about 20.9%).

Here, a solid line shown in FIG. 6 represents a purge flow rate of an inert gas which is introduced in the kneading chamber 2, and a broken line shown in FIG. 6 represents the oxygen concentration of an atmospheric gas introduced in the oxygen analyser 4.

In the batch processing during which the arithmetic operation has been stopped, it is not necessary to measure the inside of the kneading chamber 2 by the oxygen analyser 4, except for a specific case which is described in a step S12. Accordingly, when the batch processing to which the arithmetic operation is stopped is performed, it is possible to switch a four-way valve 20 so that a first flow Fl is shut and a third flow F3 is released. Accordingly, zero gas which is introduced to piping 5b from the third gas introduction line 8 (third introduction pipe 23) via the four-way valve 20 flows into the oxygen analyser 4. Therefore, the oxygen concentration shown by a broken line in FIG. 6 constantly shows 0 (volume %).

After the material G is fed, the inside of the kneading chamber 2 is set to a sealed state, and an inert gas is introduced in the kneading chamber 2 via the first gas feed line 3 to perform purge before kneading, while the oxygen concentration of zero gas flowing from the third introduction pipe 23 is measured by the oxygen analyser 4.

Purge before kneading is performed based on the conditions similar to those of the initial batch. Concretely, for example, as shown in a graph of FIG. 6, for the batches which are treated after the arithmetic operation is stopped, purge before kneading is performed while controlling a purge flow rate and purge time of an inert gas, which is introduced in the kneading chamber 2 by the first gas introduction line 3, by the control section 31 based on the arithmetic operation results of the previous batch, wherein the results are included in the aforementioned allowable range, in other words, using the values used in the step S3 and the step S9. That is, the control section 31 introduces an inert gas into the kneading chamber 2 from the first gas feed line 3, while the flow rate of the introduced inert gas (a purge before kneading flow rate Qb) is set to the fixed value for a period of time (purge before kneading time Tb) until the oxygen concentration in the kneading chamber 2 arrives at the target oxygen concentration Xa as described above. Accordingly, the inside of the kneading chamber 2 can be set to the target oxygen concentration Xa before kneading of the material G is started.

(Step S11)

Next, in the Banbury mixer 1, the process proceeds to a step S11 (purge during kneading step performed after arithmetic operation is stopped) shown in FIG. 2. In the step, kneading of the material G is started, and purge during kneading is performed to suppress an increase of the oxygen concentration in the kneading chamber 2 during kneading.

Concretely, for example, as shown by a purge flow rate of a graph of FIG. 6, in the batch which is treated after arithmetic operation is stopped, a purge during kneading is performed, while controlling a purge flow rate and purge time of an inert gas, which is introduced in the kneading chamber 2 by the first gas introduction line 3, by the control section 31 based on the result of the arithmetic operation of the previous batch, wherein the values are included in the allowable range, in other words, using values used in the steps S4 and S10.

That is, the control section 31 introduces an inert gas into the kneading chamber 2 from the first gas feed line 3, while a flow rate of the introduced inert gas (a purge during kneading flow rate Qc′ or a previous batch purge during kneading flow rate Qe′) is set to the fixed value for a period of time wherein a material to be kneaded G is kneaded (purge during kneading time Tc′). In this way, it is possible to maintain the inside of the kneading chamber 2 to the target oxygen concentration Xa while kneading is performed.

(Step S12)

After batch processing wherein the step S8 and the step S11 are combined has been completed, then, in the Banbury mixer 1, the process proceeds to a step S12 (step of confirming the number of batches) shown in FIG. 2 to determine whether or not the number of batches after arithmetic operation is stopped arrives at the predetermined number. Then, when the number of the batches treated after arithmetic operation is stopped does not arrive at the predetermined number, the process returns again to the step S8, and processing of a new batch is repeated until the number arrives at the predetermined times.

On the other hand, when the number of the batches which are treated after arithmetic operation is stopped arrives at the predetermined number, measurement of the oxygen concentration is performed in a subsequent batch to judge whether or not the oxygen concentration thereof is included in the allowable range. That is, the process returns to the step S9, the purge before kneading S9 and the purge during purge S10 (which includes purge during kneading measurement S13) are performed using the values used in the previous batch, and then, the process proceeds to the step S6 again to confirm whether or not the oxygen concentration in the kneading chamber 2 is in the aforementioned range. Then, when the oxygen concentration measured is in the aforementioned allowable range, the process proceeds to the step S8. On the other hand, when the oxygen concentration measured is not in the allowable range, the process proceeds to the step S7 to restart the arithmetic operation by the arithmetic operation section 30. Here, when it is confirmed that the predetermined number of batches have been treated in the step S12, that is, the final batch has been reached, driving of the Banbury mixer 1 is stopped after the final batch is completed.

Here, in the step S6, when the oxygen concentration in the kneading chamber 2 is not included in the allowable range, it is possible to notify by, for example, giving warning using light, sound and the like. In such a case, measurement in the kneading chamber is continuously and forcibly performed by the oxygen analyser 4 until the batch has been treated. This is performed to maintain the product quality, and an intake amount of an inert gas introduced in the kneading chamber 2 is controlled so that the oxygen concentration in the kneading chamber 2 does not exceed the allowable range, by switching the conditions so that the oxygen concentration in the kneading chamber 2 is continuously measured.

As described above, in the present invention, it is possible to stably maintain the inside of the kneading chamber 2 in an allowable range for each batch, wherein the center of the range is the target oxygen concentration Xa, by performing drive control of the Banbury mixer 1 based on the chart shown in FIG. 2.

Furthermore, in the Banbury mixer 1 of the present invention, the oxygen analyser 4 can stop the measurement of the oxygen concentration in the kneading chamber 2, after arithmetic operation performed by the arithmetic operation section 30 is stopped. Accordingly, in the Banbury mixer 1, during the period wherein the arithmetic operation has been stopped, the purge during kneading can be performed, for example, without measuring the oxygen concentration (purge during kneading measurement) in the kneading chamber 2 by the oxygen analyser 4. In such a case, since it is not necessary to continuously perform the measurement of the oxygen concentration in the kneading chamber 2, it is possible to suppress the clogging of the piping 5a and the filter 6.

(Stopping of Measurement of the Oxygen Concentration, and Reverse Purge)

Here, in the general Banbury mixer, if the measurement of the oxygen concentration is continuously performed during kneading, frequency of cleaning of the piping 5a, which exists at the inlet side, and frequency of occurrence of clogging of the filter 6 which is caused by dust collected therein increase. In order to avoid troublesome operations such as cleaning of the piping 5a, exchange of the filter 6 and the like, which are performed to prevent the above problems, reverse purge may be performed. That is, in the Banbury mixer 1 to which the first aspect of the present invention is applied, it is possible to remove dust and the like, which are collected in the piping 5a and the filter 6, by performing so-called reverse purge as used in the second aspect of the present invention, wherein a reverse purge gas is introduced from the second gas introduction line 7 to the filter 6.

Concretely, in the Banbury mixer 1, as shown in FIG. 1, while the oxygen analyser 4 measures the oxygen concentration in the kneading chamber 2, a first flow F1 is released, a second flow F2 is shut, and a third flow F3 is shut by the four-way valve 20. Accordingly, after the atmospheric gas in the kneading chamber 2 is purified by the filter 6 via the pipings 5a and 5b, the gas flows into the oxygen analyser 4.

On the other hand, while the oxygen analyser 4 interrupts the measurement of the oxygen concentration in the kneading chamber 2 in the step S8 and the step S11, switching of the four-way valve 20 is performed so that the first flow Fl is shut and the third flow F3 is released. In this case, zero gas introduced by the piping 5b flows into the oxygen analyser 4 from the third gas feed line 8 (third gas feed pipe 23) via the four-way valve 20. Due to the method, a state (standby state) wherein the oxygen analyser 4 can perform measurement can be maintained even while the oxygen analyser 4 interrupts the measurement of the oxygen concentration in the kneading chamber 2. Accordingly, without performing calibration of the oxygen analyser 4 over again, the measurement of the oxygen concentration in the kneading chamber 2 can be started immediately by switching of the four-way valve 20.

Furthermore, in the first aspect of the present invention, while the oxygen analyser 4 interrupts the measurement of the oxygen concentration in the kneading chamber 2, that is, between the step S8 and the step S11, the second flow F2 can be released due to the switching of the four-way valve 20. In this case, the reverse purge gas, which is introduced in the piping 5a from the second gas feed line 7 (second introduction pipe 21) via the four-way valve 20, flows into the filter 6.

Here, in the second gas feed line 7, pressure and a flow rate of a reverse purge gas which flows in the second introduction pipe 21 are adjusted in advance so that dust and the like collected at the piping 5a and the filter 6 are blown away to the side of the kneading chamber 2 due to power of the reverse purge gas introduced in the piping 5a. Then, reverse purge is performed by switching the four-way valve 20 so that dust and the like, which have been collected in the piping 5a and the filter 6, are removed.

Furthermore, as a method of introducing a reverse purge gas, a method wherein the reverse purge gas is continuously introduced (referred to as continuous purge) can be used. In this case, after the reverse purge gas is introduced for a fixed term, the second flow F2 is shut by switching the four-way valve 20. On the other hand, it is also possible to use a method wherein switching of the four-way valve 20 is repeated multiple times while the oxygen analyser 4 interrupts the measurement of the oxygen concentration in the kneading chamber 2 so that the reverse purge gas is intermittently introduced (referred to as intermittent purge). For example, when a reverse purge gas is intermittently introduced by switching the four-way valve 20 every one minute, the reverse purge gas can be introduced at high pressure. Here, an inert gas is preferably used as the reverse purge gas which is used for reverse purge, since the reverse purge gas is introduced via the piping 5a. However, air or the like can be also used according to circumstances.

As described above, in the Banbury mixer 1 to which the first aspect of the present invention is applied, dust and the like which are collected by the piping 5a and the filter 6 can be removed by performing the reverse purge described above, and therefore, it is possible to prevent the occurrence of clogging caused by dust and the like which have been collected by the piping 5a and the filter 6. Accordingly, when the Banbury mixer 1 is used, it is possible to measure the oxygen concentration of the inside of the kneading chamber 2 in a stable state by the oxygen analyser 4, without performing operations or the like such as cleaning of the piping 5a and exchange of the filter 6 frequently.

(Kneading Apparatus of the Second Aspect)

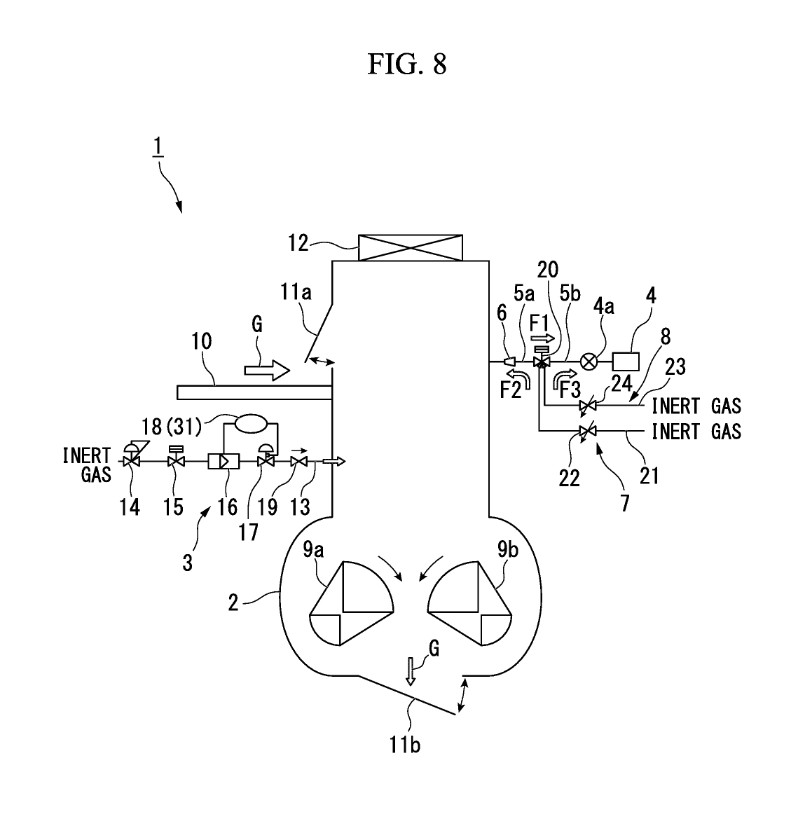

Next, preferable examples of a kneading apparatus of the second aspect of the present invention are explained using FIG. 8.

The Banbury mixer 1 as a preferable example of the second aspect of the present invention is different from that of the first aspect, in that an arithmetic operation section 30 is not included, there is no line which connects an arithmetic operation section 30 and a flow rate-controlling device or a flow rate-controlling valve, and flow control is not performed by an arithmetic operation section 30. Except for the aforementioned conditions, the Banbury mixer 1 is almost the same as the Banbury mixer 1 which is explained using FIG. 1 above. Accordingly, with respect to members thereof which are the same as those of the Banbury mixer 1 shown in FIG. 1, the same references are provided, and the explanations thereof are omitted.

In the kneading apparatus of this aspect, the measurement of the oxygen concentration may be performed based on the timing and step which can be optionally selected, and the measurement of the oxygen concentration may be interrupted at the timing and step which can be optionally selected.

Here, in the general Banbury mixer, when the oxygen concentration in the kneading chamber 2 is measured continuously during kneading, frequency of clogging caused by dust and the like which are collected to the piping 5a and the filter 6 increases, and it is necessary to perform exchange of the filter 6, cleaning of the piping 5a and the like frequently.

Accordingly, in the kneading apparatus of the second aspect of the present invention, in order to avoid troublesome operations described above, a so-called reverse purge wherein a reverse purge gas is introduced to the filter 6 from the second gas feed line 7 is performed to remove dust and the like which are collected by the piping 5a and the filter 6.

Concretely, in the Banbury mixer 1 of the second aspect, while the oxygen analyser 4 measures the oxygen concentration in the kneading chamber 2, a first flow F1 is released, a second flow F2 is shut, and a third flow F3 is shut by the four-way valve 20. Due to the structure, after an atmospheric gas in the kneading chamber 2 is purified by the filter 6 via the pipings 5a and 5b, the gas flows into the oxygen analyser 4.

On the other hand, while the oxygen analyser 4 interrupts the measurement of the oxygen concentration in the kneading chamber 2, switching of the four-way valve 20 is performed so that a first flow Fl is shut and a third flow F3 is released. In this case, zero gas, which is introduced to the piping 5b from the third gas feed line 8 (third gas feed pipe 23) via the four-way valve 20, flows into the oxygen analyser 4. Due to the method, a state (standby state) wherein the oxygen analyser 4 can perform measurement can be maintained even when the oxygen analyser 4 interrupts the measurement of the oxygen concentration in the kneading chamber 2. Accordingly, without performing calibration of the oxygen analyser 4 over again, the measurement of the oxygen concentration in the kneading chamber 2 can be started immediately by switching of the four-way valve 20.

Furthermore, while the oxygen analyser 4 interrupts the measurement of the oxygen concentration in the kneading chamber 2, the second flow F2 can be released due to the switching of the four-way valve 20. In this case, the reverse purge gas, which is introduced in the piping 5a from the second gas feed line 7 (second introduction pipe 21) via the four-way valve 20, flows into the filter 6.

Here, in the second gas feed line 7, pressure and a flow rate of the reverse purge gas which flows in the second introduction pipe 21 are adjusted in advance, so that dust and the like collected at the piping 5a and the filter 6 are blown away to the side of the kneading chamber 2 due to the power of the reverse purge gas introduced in the piping 5a. Then, reverse purge is performed by switching the four-way valve 20 so that dust and the like which are collected in the piping 5a and the filter 6 are removed.

Furthermore, as a method of introducing the reverse purge gas, a method wherein the reverse purge gas is continuously introduced (referred to as continuous purge) can be used. In this case, after the reverse purge gas is introduced for the fixed time, the second flow F2 is shut by switching the four-way valve 20. On the other hand, it is also possible to use a method wherein the switching of the four-way valve 20 is repeated multiple times during the oxygen analyser 4 interrupts the measurement of the oxygen concentration in the kneading chamber 2, so that the reverse purge gas is intermittently introduced (referred to as intermittent purge). For example, when a reverse purge gas is intermittently introduced by switching the four-way valve 20 every one minute, the reverse purge gas can be introduced at high pressure.

Here, an inert gas is preferably used as a reverse purge gas which is used for reverse purge, since the reverse purge gas is introduced in the kneading chamber 2 via the piping 5a. However, air or the like can be used according to circumstances.

As described above, in the general Banbury mixer 1 of the second aspect of the present invention, dust and the like which are collected by the piping 5a and the filter 6 can be removed by performing the reverse purge described above, and therefore, it is possible to prevent the occurrence of clogging caused by dust and the like which have been collected by the piping 5a and the filter 6. Accordingly, when the Banbury mixer 1 is used, it is possible to measure the oxygen concentration of the inside of the kneading chamber 2 in a stable state by the oxygen analyser 4, without operations or the like such as cleaning of the piping 5a and exchange of the filter 6 are frequently performed.

Here, the kneading apparatus of the second aspect of the present invention is not necessarily limited to the aforementioned embodiment. Various changes are possible in so far as they are included in the scope which does not exceed the intent of the present invention.

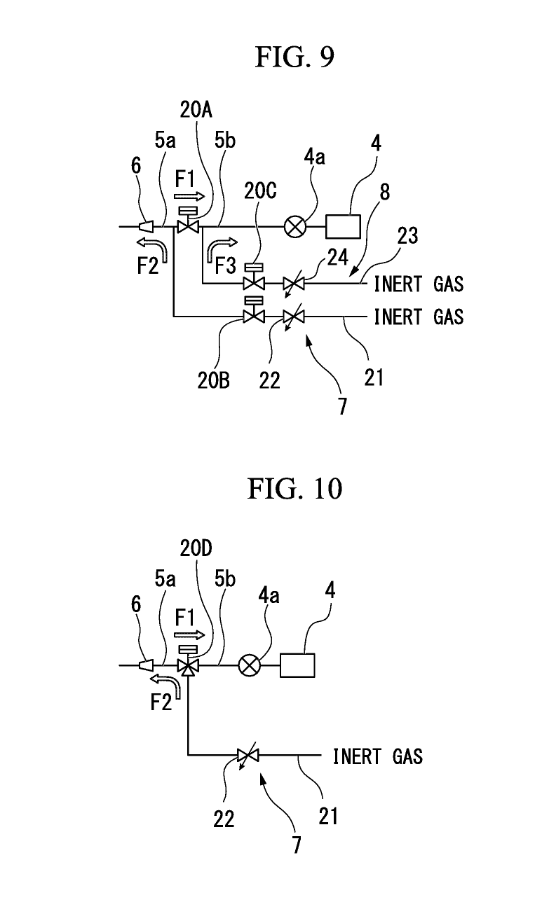

For example, the above embodiment is structured such that a four-way valve 20 is used as a switching means, which switches between a first flow F1 and a second flow F2, as shown in FIG. 8. However, the present invention is not always limited to a structure wherein such a four-way valve 20 is used. It is possible to use a structure wherein a two-way valve 20A is used as shown in FIG. 9, or a three-way valve 20B is used as shown in FIG. 10.

(Reverse Purge Using Two-Way Valve)

An example of the structure wherein a two-way valve is used is explained below.

Concretely, in the structure shown in FIG. 9, a first two-way valve 20A is provided between the piping 5a existing at the inlet side and the piping 5b existing at the outlet side. The second gas feed line 7 (second introduction pipe 21) connects with the piping 5a existing at the inlet side, and the third gas feed line 8 (third gas feed pipe 23) connects with the piping 5b existing at the outlet side. Furthermore, a second two-way valve 20B is provided between the piping 5a existing at the inlet side and the flow rate-controlling valve 22, and

a third two-way valve 20C is provided between the piping 5b existing at the outlet side and the flow rate-controlling valve 24.

In the structure shown in FIG. 9, while the oxygen analyser 4 measures the oxygen concentration in the kneading chamber 2, a first flow F1 is released by the a first two-way valve 20A, a second flow F2 is shut by a second two-way valve 20B, and a third flow F3 is shut by a third two-way valve 20C. Accordingly, after the atmospheric gas in the kneading chamber 2 is purified by the filter 6 via the pipings 5a and 5b, the gas flows into the oxygen analyser 4.

On the other hand, while the oxygen analyser 4 interrupts the measurement of the oxygen concentration in the kneading chamber 2, the first flow Fl is shut by the first two-way valve 20A, and the third flow F3 is released by the third two-way valve 20C. In this case, zero gas, which is introduced to the piping 5b from the third gas feed line 8 (third gas feed pipe 23), flows into the oxygen analyser 4. Due to the method, a state (standby state) wherein the oxygen analyser 4 can perform measurement can be maintained even when the oxygen analyser 4 interrupts the measurement of the oxygen concentration inside the kneading chamber 2.

Furthermore, while the oxygen analyser 4 interrupts the measurement of the oxygen concentration in the kneading chamber 2, reverse purge can be performed when the second flow F2 is released by the second two-way valve 20B. Due to the structure, the reverse purge gas, which is introduced in the piping 5a existing at the inlet side from the second gas feed line 7 (second introduction pipe 21), flows into the filter 6, and dust and the like collected at the piping 5a and the filter 6 can be blown away.

(Reverse Purge Using Three-Way Valve)

An example of the structure wherein a three-way valve is used is explained below.

In the structure shown in FIG. 10, a three-way valve 20D is provided between the piping 5a existing at the inlet side and the piping 5b existing at the outlet side, and the second gas feed line 7 (second introduction pipe 21) connects with the three-way valve 20D. Here, since zero gas is not introduced in the oxygen analyser 4, the third gas feed line 8 (third gas feed pipe 23 and a flow rate-controlling valve 24) is not included.

Furthermore, in the structure shown in FIG. 10, while the oxygen analyser 4 measures the oxygen concentration in the kneading chamber 2, a first flow F1 is released, and a second flow F2 is shut by the three-way valve 20D. Accordingly, after an atmospheric gas in the kneading chamber 2 is purified by the filter 6 via the pipings 5a and 5b, the gas flows into the oxygen analyser 4, and the oxygen concentration is measured.

On the other hand, while the oxygen analyser 4 interrupts the measurement of the oxygen concentration in the kneading chamber 2, the three-way valve 20D closes the first flow F1.

Here, the aforementioned pump 4a is stopped to make the oxygen analyser 4 in a stopped condition. When the oxygen analyser 4 interrupts measurement of the oxygen concentration, a flow rate-controlling valve 22 is opened to perform reverse purge. Accordingly, a reverse purge gas, which is introduced in to the piping 5a existing at the inlet side from the second gas feed line 7 (second introduction pipe 21) via three-way valve 20D, flows into a filter 6.

Accordingly, dust and the like collected at the piping 5a and the filter 6 can be removed.

(Removal of Dust Using Dust Collector)

Next, a dust removal method wherein a dust collector 12 is used is explained.

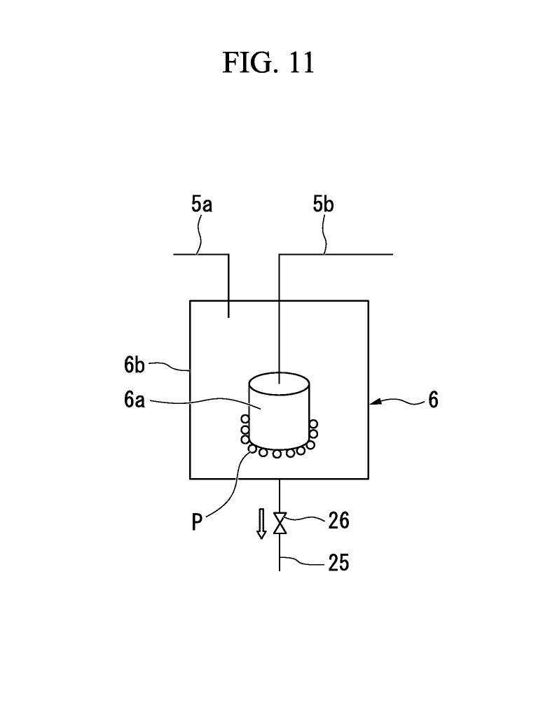

In the present invention, it is possible to use a structure wherein dust and the like such as dust P which are collected by the filter 6 as shown in FIG. 11 may be removed by aspiration which is performed by a dust collector 12 as shown in FIG. 8 (not shown in FIG. 11).

FIG. 11 is explained concretely below. Piping 25 is provided to combine the dust collector 12 and the filter 6. Furthermore, between the dust collector 12 and the filter 6, an on-off valve 26 which is configured to open and close the piping 25 is provided. In general, the filter 6 has a structure wherein an element 6a which collects dust P is provided in a collection container 6b.

In this case, when the oxygen analyser 4 interrupts the measurement of the oxygen concentration in the kneading chamber 2, the piping 25 can be released by the on-off valve 26 to let a gas flow into the collection container 6b from the piping 5a existing at the inlet side, so that dust P collected at the element 6a in the collection container 6b is released and is removed by aspiration performed by the dust collector 12. Accordingly, when the structure is used, it is possible to furthermore increase the life span of the filter 6. The timing of opening the on-off valve 26 may be performed before the aforementioned reverse purge, wherein the four-way valve 20, the two-way valve 20A, the three-way valve 20D or the like is used, during the reverse purge, or after the reverse purge.

Here, the present invention is not necessarily limited to the aforementioned embodiment, and various changes may be applicable without departing from the scope of the present invention.

For example, a kneading apparatus to which the present invention is applied is not limited to the Banbury-mixer shown in FIGS. 1 and 8, and for example, a kneader mixer or the like may be used.

Furthermore, in the present invention, in addition to the method wherein the oxygen concentration in the kneading chamber 2 is directly measured by the oxygen analyser 4, it is also possible to use a method wherein the oxygen concentration in the kneading chamber 2 is indirectly measured, for example, it is possible to use a method wherein the concentration of an inert gas which is introduced in the kneading chamber 2 is measured.

### EXAMPLES

The effects of the present invention are specifically shown below with Examples. Here, the present invention is not limited to Examples below, and can be properly modified and carried out in so far as the content of the present invention is not changed.

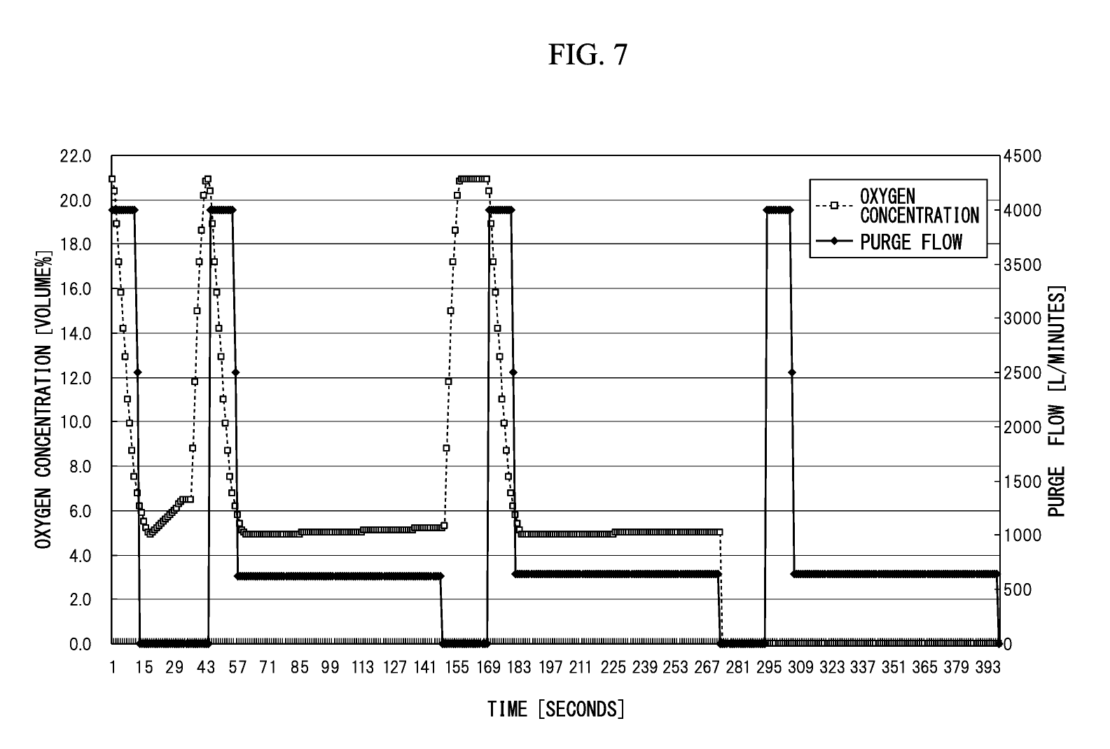

In this Example, the Banbury mixer 1 shown in FIG. 1 was actually used, and a kneading step of a rubber to be kneaded (material to be kneaded G), which is counted as one batch production, was repeated until 200 batches had been treated. When the kneading step is performed, drive control of the Banbury mixer 1 was performed according to a flowchart shown in FIG. 2. At the time, the oxygen concentration in the kneading chamber 2 and a purge flow rate of a nitrogen gas (inert gas) which is introduced in the kneading chamber 2 were measured. FIG. 7 shows a graph of the measured results from the initial purge until the third batch processing was performed. Here, a solid line shown in FIG. 7 represents a purge flow rate of an inert gas which is introduced in the kneading chamber 2, and a broken line shown in FIG. 7 represents the oxygen concentration of the atmospheric gas introduced in the oxygen analyser 4.

(Steps S1 and S2)

In the Banbury mixer 1, arithmetic operation was first performed by an arithmetic operation section 30 to obtain the initial purge time Ta.

Here, conditions used for obtaining the initial purge time Ta are shown below.

Target oxygen concentration Xa: 5.0 (volume %)

Oxygen concentration of air X0: 20.9 (volume %)

Initial purge flow rate Qa: 4000 (NL/minute)

Inner volume of a kneading chamber V0: 1000 (L)

Accordingly, the initial purge time Ta was 21.45 seconds, according to the results of arithmetic operation using the aforementioned formula (2).

Next, initial purge was performed. Then, at first, before a material to be kneaded G was fed in the kneading chamber 2, the oxygen concentration inside the kneading chamber 2 was set to the oxygen concentration of air, by opening the injection door 11a without introducing an inert gas, so that the inside of the kneading chamber 2 was exposed to air. Subsequently, the inside of the kneading chamber 2 was set to a sealed state without feeding a material G, and an inert gas was introduced at 4000 NL/minute (initial purge flow rate Qa) for 21.45 seconds (initial purge time Ta) in the kneading chamber 2 via the first gas feed line 3, while the oxygen concentration in the chamber was measured by the oxygen analyser 4.

Then, initial purge was measured. That is, the introduction of the inert gas into the kneading chamber 2 was stopped, and after it was confirmed that the oxygen concentration in the kneading chamber 2 arrived at the lowest value during kneading, the measurement of the oxygen concentration (initial purge measurement) was performed by the oxygen analyser 4 during a fixed period (initial purge measurement time Tc) while the introduction of an inert gas was interrupted.

Furthermore, based on the measurement results of the oxygen concentration measured by the oxygen analyser 4, the arithmetic operation section 30 performed arithmetic operation to obtain an initial purge predicted flow rate Qc which was a flow rate of an inert gas to offset the increment of the oxygen concentration.

Here, conditions used for obtaining the initial purge predicted flow rate Qc are shown below.

Inner volume of the kneading chamber V0: 1000 (L)

Inner volume of the kneading chamber after feeding V: (L)

Initial purge measurement time Tc: 15 (seconds)

Lowest value Xb (measured value) of the oxygen concentration in the initial purge measurement time (Tc): 5.0 (volume %)

Uppermost value Xc (measured value) of the oxygen concentration in the initial

purge measurement time: 6.5 (volume %)

Accordingly, the initial purge predicted flow rate Qc was 1050 NL/minute, according to the results of arithmetic operation using the aforementioned formula (3).

Before kneading of the initial batch was performed, arithmetic operation was performed by the arithmetic operation section 30 to obtain purge before kneading time Tb.

Here, conditions used for obtaining the purge before kneading time Tb are shown below.

Inner volume of the kneading chamber V0: 1000 (L)

Volume of a material to be kneaded G Vg: 420 (L)

Space coefficient of a material to be kneaded G kg: 0.97

Flow rate of purge before kneading Qb: 4000 NL/minute Accordingly, the inner volume V of the kneading chamber after feeding was 592.6 L and the purge before kneading time Tb was 12.71 seconds according to the results of arithmetic operation using the aforementioned formulae (4) and (5).

Furthermore, arithmetic operation was performed by the arithmetic operation section 30 to obtain a purge during kneading flow rate Qc'.

Here, conditions used for obtaining the purge during kneading flow rate Qc' are shown below.

Inner volume of the kneading chamber V0: 1000 (L)

Inner volume of the kneading chamber after feeding V: 592.6 (L)

Purge during kneading time Tc′: 90 (seconds)

Accordingly, the volume ratio λ was 0.5926 and the purge during kneading flow rate Qc′ was 622 NL/minute, according to the results of arithmetic operation using the aforementioned formulae (6) and (7).

(Step S3)

Subsequently, processing of an initial batch (first batch) was started to perform purge before kneading. That is, the injection door 11a was opened to expose the inside of the kneading chamber 2 to air, before a material to be kneaded G was introduced in the kneading chamber 2, so that the oxygen concentration in the kneading chamber 2 reached the oxygen concentration of air.

Subsequently, after a material to be kneaded G was fed, the inside of the kneading chamber 2 was set to a sealed state, and an inert gas was introduced at 4000 NL/minute (purge before kneading flow rate Qb) for 12.71 seconds (purge before kneading time Tb) in the kneading chamber 2 via the first gas feed line 3, while the oxygen concentration in the chamber was measured by the oxygen analyser 4.

(Steps S4 and S5)

Subsequently, the introduction of the inert gas into the kneading chamber 2 performed by the purge before kneading was stopped, kneading of the material G was started, while a purge during kneading was performed. That is, an inert gas was introduced at 622 NL/minute (purge during kneading flow rate Qc′) for 90 seconds (purge during kneading time Tc′) in the kneading chamber 2 via the first gas feed line 3.

Furthermore, the aforementioned purge during kneading measurement time Te was obtained. That is, the introduction of the inert gas into the kneading chamber 2, which was performed during the purge before kneading, was stopped, and after it was confirmed that the oxygen concentration in the kneading chamber 2 arrived at the lowest value by the oxygen analyser 4, the time until the oxygen concentration arrived at the uppermost value was obtained, and the obtained values was set as purge during kneading measurement time Te.

(Steps S6 and S7)

Then, as the result of the measurement of the oxygen concentration measured by the oxygen analyser 4, it was confirmed that the lowest value of the oxygen concentration in the purge during kneading time Tc' was not included in the allowable range (5±0.1 volume %). Since the value was out of the allowable range, arithmetic operation used to obtain the purge during kneading correction flow rate q was obtained.

Here, conditions used for obtaining the purge during kneading correction flow rate q were as follows.

Inner volume of the kneading chamber after feeding V: 592.6 (L)

Purge during kneading measurement time Te (measured value): 62 (seconds)

Lowest value Xd (measured value) of the oxygen concentration in the purge during kneading measurement time Tc′: 5.0 (volume %)

Uppermost value Xe (measured value) of the oxygen concentration in the purge during kneading measurement time Tc′: 5.2 (volume %)

Accordingly, the purge during kneading correction flow rate q was −23 NL/minute, according to the results of arithmetic operation using the aforementioned formula (8).

Furthermore, arithmetic operation was performed by the arithmetic operation section 30 using the formula (9) to obtain the subsequent batch purge during kneading flow rate Qe. As the result, it was confirmed that the subsequent batch purge during kneading flow rate Qe was 645 NL/minute.

(Step S9)

Next, the second batch was started, and the purge before kneading was performed. That is, when a material to be kneaded G was introduced in the kneading chamber 2, introduction of an inert gas was stopped, and the injection door 11a was opened to expose the inside of the kneading chamber 2 to air, so that the oxygen concentration in the kneading chamber 2 reached the oxygen concentration of air. Subsequently, after the material G was fed, the inside of the kneading chamber 2 was set to a sealed state, and an inert gas was introduced at 4000 NL/minute (purge before kneading flow rate Qb) for 12.71 seconds (purge before kneading time Tb) in the kneading chamber 2 via the first gas feed line 3, while the oxygen concentration in the chamber was measured by the oxygen analyser 4.

(Step S10)

Subsequently, after the introduction of the inert gas into the kneading chamber 2, which was performed by the purge before kneading, was performed, kneading of the material G and the purge during kneading were performed. An inert gas was introduced in the kneading chamber 2 via the first gas feed line 3 based on the values obtained in the step S6, that is, at 645 NL/minute (subsequent batch purge during kneading flow rate Qe) for 90 seconds (purge during kneading time Tc′).

(Step S13)

Furthermore, the purge during kneading measurement time Te was obtained. That is, the purge during kneading was performed, and the time between when it was confirmed that the oxygen concentration in the kneading chamber 2 arrived at the lowest value by the oxygen analyser 4 and when the oxygen concentration subsequently arrived at the uppermost value was obtained, and the obtained time was set as purge during kneading measurement time Te.

(Step S6 of the Second Batch)

Them, in the purge during kneading purge time Tc′, the measurement result of the oxygen concentration measured by the oxygen analyser 4 was in the allowable range (5.0±0.1 volume %). Due to the result, arithmetic operation which was performed for obtaining the purge during kneading correction flow rate q was stopped. Similarly, measurement of the oxygen concentration was also stopped.

(Step S8)

Subsequently, the third batch was started, and the purge before kneading was performed. That is, when a material to be kneaded G was introduced in the kneading chamber 2, introduction of an inert gas was stopped, and the injection door l la was opened to expose the inside of the kneading chamber 2 to air, so that the oxygen concentration in the kneading chamber 2 reached the oxygen concentration of air. Subsequently, after the material G was fed, the inside of the kneading chamber 2 was set to a sealed state, and an inert gas was introduced at 4000 NL/minute (purge before kneading flow rate Qb) for 12.71 seconds (purge before kneading time Tb) in the kneading chamber 2 via the first gas feed line 3, while the oxygen concentration in the chamber 2 was not measured but the oxygen concentration of zero gas was measured by the oxygen analyser 4.

Here, after the arithmetic operation was stopped, it was not necessary to perform measurement of the inside in the kneading chamber 2 by the oxygen analyser 4, and therefore, a four-way valve 20 was switched so that a first flow F1 was shut and a third flow F3 was released. Due to the switching, zero gas (oxygen concentration (0 volume %)) was introduced to the piping 5b from the third gas introduction line 8 (third introduction pipe 23) via the four-way valve 20 and flowed into the oxygen analyser 4. Accordingly, the oxygen concentration shown by a broken line in FIG. 7 constantly shows 0 (volume %).

(Step S11)

Subsequently, the introduction of the inert gas into the kneading chamber 2 performed by the purge before kneading was stopped, and kneading of the material G was started, while the purge during kneading was performed. That is, an inert gas was introduced at 645 NL/minute (subsequent batch purge during kneading flow rate Qe) for 90 seconds (purge during kneading time Tc′) in the kneading chamber 2 via the first gas feed line 3.

(Step S12)

Subsequently, after the arithmetic operation was stopped, the steps S8 and S11 were repeated until the predetermined number was performed.

(Step S6)

For a batch (twenty-second batch counted from the start of kneading) which was treated subsequent to the twentieth batch which was counted from when the arithmetic operation and the measurement of the oxygen concentration were stopped, purge before kneading (step S9), purge during kneading (step S10) and purge during kneading measurement (step S13) were performed to confirm whether or not the oxygen concentration thereof was in the allowable range. The purge during kneading flow rate Qe of this batch was the same as that of the previous batch.

Here, setting was performed such that when the result of the above measurement was in the allowable range, the process proceeded to the second time step S8, and when the result of the above measurement was not in the allowable range, the process proceeded to the second time step S7. In the present experiment, steps were repeated until 200 batches, and the measured oxygen concentration was included in the allowable range until the last measurement was performed.

That is, after the arithmetic operation was stopped, it was confirmed every twenty batches whether or not the oxygen concentration in the kneading chamber 2 was included in the allowable range. As the result, it was confirmed that the oxygen concentration in the kneading chamber 2 was in the allowable range until the final batch (two hundredth batch) was treated, and no extreme increase or decrease of the oxygen concentration was observed.

As described above, by performing drive control of the Banbury mixer 1 of the present invention, it is possible to stably maintain the inside of the kneading chamber 2 for every batch to the target oxygen concentration Xa.

Further, in the step performed after the arithmetic operation was stopped, reverse purge was performed wherein the oxygen analyser 4 stopped the measurement of the oxygen concentration in the kneading chamber 2 and switching of the four way valve 20 was performed so that the reverse purge gas flowed into the filter 6 provided at the piping 5a via the second introduction pipe 21. As the result, it was confirmed that dust and the like collected at the piping 5a and the filter 6 was removed.

### INDUSTRIAL APPLICABILITY

The present invention can provide a kneading apparatus which enables the inside of the kneading chamber to be maintained at the target oxygen concentration. Furthermore, it is possible to provide a kneading apparatus which can prevent clogging of piping and a filter, and can measure the oxygen concentration of the inside of the kneading chamber stably without frequently performing operations or the like such as cleaning of the piping and exchange of the filter.

### BRIEF DESCRIPTION OF THE REFERENCE SYMBOLS

1 Banbury mixer

2 Kneading chamber

3 First gas feed line (first gas feed means)

4 Oxygen analyser (concentration measurement means)

4a Pump

5a Piping at the inlet side

5b Piping at the outlet side

6 Filter

6a Element

6b Collection container

7 Second gas feed line (second gas feed means)

8 Third gas feed line (third gas feed means)

9a, 9b Rotor

10 Belt conveyor

11a Injection door

11b Discharge door

12 Dust collector

13 First introduction pipe

14 Pressure-regulating valve

15 Shut-off valve

16 Flowmeter

17 Flow rate-controlling meter

18 Flow rate controller

19 Check valve

20 Four-way valve (switching means)

20A First two-way valve

20B Second two-way valve

20C Third two-way valve

20D Three-way valve

21 Second introduction pipe

22 Flow rate-controlling valve

23 Third introduction pipe

24 Flow rate-controlling valve

25 Piping

26 On-off valve

30 Operation section (arithmetic means)

31 Control section (control means)

G Material to be kneaded

F1 First flow

F2 Second flow

F3 Third flow

1. A kneading apparatus comprising:
a kneading chamber which kneads a material to be kneaded;
a gas introduction part which introduces an inert gas in the kneading chamber;
a concentration measurement part which measures oxygen concentration of the inside of in the kneading chamber;
an arithmetic operation section which performs an arithmetic operation to make the inside of the kneading chamber achieve target concentration; and
a control section which controls the gas introduction part based on the arithmetic result obtained by the arithmetic operation section; wherein the arithmetic operation section performs the arithmetic operation to set the inside of the kneading chamber to the target oxygen concentration while comparing the oxygen concentration which is actually measured during kneading by the concentration measurement part and the target oxygen concentration which is set in advance, and
in a kneading step which is performed after the arithmetic operation, the control section controls a purge flow rate and purge time of an inert gas, which is introduced in the kneading chamber from the gas introduction part, based on the obtained arithmetic result obtained by the arithmetic operation section.

2. The apparatus according to claim 1, wherein the apparatus is a batch type kneading apparatus, wherein feeding, kneading and discharging of a material to be kneaded are performed as a kneading step to treat one batch, and the kneading step is repeated two or more times; the arithmetic operation section repeats arithmetic operation to maintain the target oxygen concentration for each batch; and the control section controls the purge flow rate and purge time of the inert gas, which is introduced in the kneading chamber from the gas introduction part, based on the arithmetic results.

3. The apparatus according to claim 2, wherein the control section exposes the inside of the kneading chamber to air before each batch start, seals the kneading chamber after the exposure to air, and starts the introduction of an inert gas into the kneading chamber by the gas introduction part.

4. The apparatus according to claim 2, wherein the inside of the kneading chamber is exposed to air before an initial batch starts and then the kneading chamber is sealed after the exposure,
the gas introduction part introduces an inert gas in the kneading chamber until the oxygen concentration in the kneading chamber becomes the target oxygen concentration while the concentration measurement part measures the oxygen concentration in the sealed kneading chamber,
subsequently, the arithmetic operation section calculates a purge flow rate of an inert gas which offsets an increment of the oxygen concentration increased in a fixed time, while the concentration measurement part measures the oxygen concentration in the kneading chamber for the fixed time, and
the arithmetic operation section uses the obtained purge flow rate as a standard value, which is used to maintain the inside of the kneading chamber at the target oxygen concentration, during kneading of the initial batch.

5. The apparatus according to claim 2, wherein the concentration measurement part actually measures the oxygen concentration of initial and following batches,
the arithmetic operation section compares the oxygen concentration of a batch, wherein the oxygen concentration is actually measured by the concentration measurement part, and the target oxygen concentration which is set in advance, and performs arithmetic operation to obtain a flow rate of an inert gas which offsets the difference of the oxygen concentrations, and
the obtained flow rate is used as a correction value to maintain the inside of the kneading chamber to the target oxygen concentration during kneading of a subsequent batch, which is treated after the batch wherein the oxygen concentration thereof is actually measured.

6. The apparatus according claim 5, wherein, when the oxygen concentration of the batch which is actually measured by the concentration measurement part is included in a predetermined allowable range which includes the target oxygen concentration, arithmetic operation performed by the arithmetic operation section is stopped in subsequent and following batches, and
the control section controls the purge flow rate and purge time of the inert gas, which is introduced in the kneading chamber from the gas introduction part during kneading of the subsequent and following batches, based on the arithmetic results which are included in the allowable range.

7. The apparatus according to claim 6, wherein, after the arithmetic operation performed by the arithmetic operation section is stopped,
the concentration measurement part measures the oxygen concentration in the kneading chamber on a regular basis,
the arithmetic operation section resumes arithmetic operation when the measured oxygen concentration exceeds the allowable range, and
the control section controls the purge flow rate and purge time of the inert gas, which is introduced in the kneading chamber from the gas introduction part, based on the obtained arithmetic results.

8. The apparatus according to claim 7, wherein, when the concentration measurement part measures the oxygen concentration in the kneading chamber on a regular basis and the measured the oxygen concentration is lower than the allowable range,
the result is notified and the concentration measurement part continues to measure oxygen concentration in the kneading chamber until the processing of the batch is completed.

9. The apparatus according to claim 1, wherein the apparatus includes:
piping which introduces an atmospheric gas in the kneading chamber to the concentration measurement part;
a filter which collects dust included in the atmospheric gas which flows in the piping; and
a second gas introduction part which introduces a reverse purge gas to the filter from the piping existing at the side of the concentration measurement part.

10. The apparatus according to claim 9, wherein the apparatus includes a switching part, wherein
the switching part switches a first flow wherein the atmospheric gas in the kneading chamber flows toward the concentration measurement part in the piping and a second flow wherein the reverse purge gas which is introduced from the second gas introduction part flows toward the filter in the piping;
the switching part releases the first flow and shuts the second flow while the concentration measurement part measures the oxygen concentration in the kneading chamber; and
the switching part shuts the first flow and releases the second flow to introduce a reverse purge gas into the filter from the piping existing at the side of the concentration measurement part, while the concentration measurement part interrupts measurement of the oxygen concentration in the kneading chamber.

11. The apparatus according to claim 10, wherein the apparatus includes a third gas introduction part which introduces zero gas to the concentration measurement part,
the switching part shuts a third flow wherein the zero gas introduced from the third gas introduction part flows toward the concentration measurement part in the piping, while the concentration measurement part measures the oxygen concentration in the kneading chamber, and
the switching part releases the third flow to let the third flow flow toward the concentration measurement part in the piping, while the concentration measurement part interrupts measurement of the oxygen concentration in the kneading chamber.

12. The apparatus according to claim 9, wherein the reverse purge gas is an inert gas.

13. The apparatus according to claim 11, wherein the zero gas is an inert gas.

14. A kneading apparatus comprising;
a kneading chamber in which a material to be kneaded is kneaded;
a first gas introduction part which introduces an inert gas into the kneading chamber;
a concentration measurement part which measures oxygen concentration in the kneading chamber;
a piping which introduces an atmospheric gas in the kneading chamber toward the concentration measurement part;
a filter which collects dust included in the atmospheric gas which flows in the piping; and
a second gas introduction part which introduces a reverse purge gas to the filter from the piping existing at the side of the concentration measurement part.

15. The apparatus according to claim 14, wherein the apparatus includes a switching part, which switches a first flow wherein an atmospheric gas in the kneading chamber flows toward the concentration measurement part in the piping and a second flow wherein a reverse purge gas which is introduced from the second gas introduction part flows toward the filter in the piping;
the switching part releases the first flow and shuts the second flow, while the concentration measurement part measures the oxygen concentration in the kneading chamber; and
the switching part shuts the first flow and releases the second flow to introduce a reverse purge gas into the filter from the piping existing at the side of the concentration measurement part, while the concentration measurement part interrupts measurement of the oxygen concentration in the kneading chamber.

16. The apparatus according to claim 15, wherein the apparatus includes the third gas introduction part which introduces zero gas to the concentration measurement part, wherein
the switching part shuts the third flow wherein the zero gas introduced from the third gas introduction part flows toward the concentration measurement part in the piping while the concentration measurement part measures the oxygen concentration in the kneading chamber, and
the switching part releases the third flow and the third flow flows toward the concentration measurement part while the concentration measurement part interrupts measurement of the oxygen concentration in the kneading chamber.

17. The apparatus according to claim 14, wherein the apparatus includes:
a dust collector which collects dust included in the kneading chamber,
piping which connects the dust collector and the filter, and
an on-off valve which is configured to open and close the piping, wherein,
when the concentration measurement part stops measurement of the oxygen concentration in the kneading chamber, the piping is opened by the on-off valve to remove dust, which has been collected to the filter, while performing aspiration by the dust collector.

18. The apparatus according to claim 14, wherein the reverse purge gas is an inert gas.

19. The apparatus according to claim 14, wherein the zero gas is an inert gas.

20. A kneading process, wherein an kneading apparatus is used and a material to be kneaded is fed and kneaded in a kneading chamber of the apparatus and discharged from the chamber, the method comprising;
a step (a) of performing arithmetic operation by the arithmetic operation section to make the inside of the kneading chamber achieve the target concentration while comparing the oxygen concentration which is actually measured during kneading by the concentration measurement part and the target oxygen concentration which is predicted in advance; and
a step (b) of controlling the purge flow rate and purge time of the inert gas, which is introduced in the kneading chamber from the gas introduction part, based on the obtained arithmetic result by the control section during kneading which is performed after the arithmetic operation.

21. The kneading process according to claim 20, wherein the steps (a) and (b) include the sub-steps (1) to (5) below:
(1) an initial purge step wherein
initial purge time, which is used for making the inside of the kneading chamber, which is sealed after exposure to air, achieve a target oxygen concentration, is obtained based on a value of an initial purge flow rate which is set in advance,
an inert gas is fed in the kneading chamber at the initial purge flow rate and the introduction of the inert gas is stopped when the initial purge time has passed, and
variations of the oxygen concentration of the inside of the kneading chamber are measured during a fixed period;
(2) an initial batch step which includes steps (2a) to (2c) in this order:
(2a) a purge before kneading step wherein a material to be kneaded is fed in the kneading chamber and sealed, and an inert gas is introduced in the kneading chamber at a predetermined purge flow rate and purge time;
(2b) a purge during kneading step wherein kneading of the material to be kneaded is started after the purge time has passed, and variations of the oxygen concentration during kneading are measured while an inert gas is introduced in the kneading chamber at the purge flow rate which is obtained based on the variations of the oxygen concentration obtained in in the step (1);
(2c) a discharging step wherein the material to be kneaded is discharged from the kneading chamber after kneading;
(3) a step wherein whether or not the variations of the oxygen concentration which is measured in the steps for a previous batch are in a predetermined allowable range is confirmed, and, when it is confirmed that the variations are not included in the allowable range, a step (4) is performed, and when it is confirmed that the variations are included in the allowable range, a step (5) is performed;
(4) a batch step wherein the step is performed for the second and following batches, and includes the following steps (4a) to (4c) in this order:
(4a) a purge before kneading step wherein a material to be kneaded is fed in the kneading chamber, from which a material to be kneaded of a previous batch has been discharged, and then, the chamber is sealed and an inert gas is introduced in the kneading chamber at the predetermined purge flow rate and purge time;
(4b) a purge during kneading step wherein kneading of the material to be kneaded is started when the purge time has passed, and variations of the oxygen concentration during kneading are measured, while an inert gas is introduced in the kneading chamber at a purge flow rate, which offsets the variations of the oxygen concentration obtained in the purge during kneading step performed for the previous batch;
(4c) a discharging step wherein the material to be kneaded is discharged from the kneading chamber; and
(5) a batch step which is performed after arithmetic operation is stopped, and includes the following steps (5a) to (5c) in this order:
(5a) a purge before kneading step wherein a material to be kneaded is fed in the kneading chamber, from which a material to be kneaded of a previous batch has been discharged, and then, the chamber is sealed and an inert gas is introduced in the kneading chamber at the predetermined purge flow rate and purge time;
(5b) a purge during kneading step wherein kneading of the material to be kneaded is started when the purge time has passed, and inert gas is introduced in the kneading chamber at a purge flow rate, which is the same as the flow rate used in the purge during kneading step performed for the previous batch; and
(5c) a discharging step wherein the material to be kneaded is discharged from the kneading chamber;
wherein the sub-steps include a step of returning to the step (3) for confirmation, wherein the step is performed
(i) after the step (4) is performed, or
(ii) after the step (5) is repeatedly performed predetermined times and the batch step is further performed wherein variations of the oxygen concentration during kneading are measured in the purge during kneading step thereof.
